(19) United States
(12) Patent Application Publication
(10) Pub. No.: US 2025/0073721 A1
(43) Pub. Date: Mar. 6, 2025

(54) TUBE CAP AND TUBE INCLUDING THE TUBE CAP

(71) Applicant: Azenta US, Inc., Burlington, MA (US)

(72) Inventors: Zoltan ERDELYI, Burlington, MA (US); Simon HOLMES, Burlington, MA (US); Paul WALSH, Burlington, MA (US); Paul DAY, Burlington, MA (US)

(21) Appl. No.: 18/459,792

(22) Filed: Sep. 1, 2023

(51) Int. Cl. B01L 3/00

(52) U.S. Cl. CPC B01L 3/50825; B01L 2300/042; B01L 2300/043

(57) ABSTRACT

A closable tube assembly including a tube vessel, a first cap assembly, and a second cap assembly. The tube vessel has walls defining an opening to an interior of the tube vessel. The first cap is removably connected to the tube vessel over the opening and engages an edge of the opening and the tube vessel interior to close the opening at least in part. The second cap is removably connected to the tube vessel and the first cap so that opening closure is commonly effected by both the first cap and the second cap. Removal of the second cap opens the opening with the first cap engaged to the edge of the opening. Both the first cap and the second cap have an insert closure configuration relative to the opening, and the second cap has an insert configuration relative to the first cap.

### BACKGROUND

### 1. Field

The exemplary embodiments generally relate to laboratory sample holders, and more particularly, to capped laboratory sample holders facilitating both manual and automated access to samples therein.

### 2. Brief Description of Related Developments

Generally laboratory samples, such as for pre-implantation genetic testing, are collected and/or stored (referred to herein as collection for convenience) in standard 0.2 mL PCR (Polymerase Chain Reaction) tubes. To store samples in the PCR tubes, the empty PCR tubes are sent t from a customer's laboratory facility to a clinician/embryologist, where cells of test embryos are manually added to the PCR tubes. The clinician/embryologist marks the filled PCR tubes with identifiers and sends the filled PCR tubes back to the customer's laboratory facility, alongside corresponding paperwork tracking the samples in the filled PCR tubes. At the customer's laboratory, the filled PCR tubes are combined with a collar on which a two-dimensional code is printed/stamped or otherwise affixed. This two-dimensional code on the collar is employed for tracking/processing the respective filled PCR tube at the customer's laboratory facility. While the collar and two-dimensional code therein effect sample tracking, the collar may become separated from the PCR tube, risking misidentification of the tubes.

The above tube filling and preparation process is slow and labor intensive. For example, the standard 0.2 mL PCR tubes must be manually decapped and capped and the collar on which the 2-d code is disposed must be affixed to each PCR tube.

There is a desire to have a laboratory sample holding solution that provides both manual insertion of samples into the sample holder (e.g., where the sample holder is manually decapped and capped) and for automated handling and processing of the samples within the sample holder. There is also a desire to improve sample tracking.

### BRIEF DESCRIPTION OF THE DRAWINGS

The foregoing aspects and other features of the disclosed embodiment are explained in the following description, taken in connection with the accompanying drawings, wherein:

FIG. 1 is an exemplary block diagram of a closable tube assembly incorporating aspects of the disclosed embodiment;

FIG. 1A is an exemplary illustration of the closable tube assembly of FIG. 1, in accordance with aspects of the disclosed embodiment;

FIG. 1B is an exemplary illustration of the closable tube assembly of FIG. 1, in accordance with aspects of the disclosed embodiment;

FIG. 1C is an exemplary illustration of the closable tube assembly of FIG. 1, in accordance with aspects of the disclosed embodiment;

FIG. 1D is an exemplary illustration of the sample access through a cap of the closable tube assembly of FIG. 1, in accordance with aspects of the disclosed embodiment;

FIG. 1E is an exemplary illustration of the closable tube assembly of FIG. 1, in accordance with aspects of the disclosed embodiment;

FIG. 2A is a schematic cross-sectional illustration of the closable tube assembly of FIG. 1, in accordance with aspects of the disclosed embodiment;

FIG. 2B is a top perspective illustration of the closable tube assembly of FIG. 2A, in accordance with aspects of the disclosed embodiment;

FIG. 2C is a bottom perspective illustration of the closable tube assembly of FIG. 2A, in accordance with aspects of the disclosed embodiment;

FIG. 2D is a top perspective illustration of the closable tube assembly of FIG. 2A in an open configuration, in accordance with aspects of the disclosed embodiment;

FIG. 3A is a schematic cross-sectional illustration of the closable tube assembly of FIG. 2A, in accordance with aspects of the disclosed embodiment;

FIG. 3B is a partial schematic cross-sectional illustration of the closable tube assembly of FIG. 3A, in accordance with aspects of the disclosed embodiment;

FIG. 3C is a top perspective illustration of the closable tube assembly of FIG. 3A, in accordance with aspects of the disclosed embodiment;

FIG. 4 is an exemplary illustration of gripper to cap engagement between a sample tube gripper and the cap of the closable tube assemblies described herein, in accordance with aspects of the disclosed embodiment;

FIGS. 5A-5F are schematic illustrations of the gripper to cap engagement of FIG. 4, in accordance with aspects of the disclosed embodiment;

FIGS. 6A and 6B are exemplary illustrations of gripper to cap engagement between a sample tube gripper and the cap of the closable tube assemblies described herein, in accordance with aspects of the disclosed embodiment;

FIGS. 7A, 7B, and 7C are exemplary illustrations of gripper to cap engagement between a sample tube gripper and the cap of the closable tube assemblies described herein, in accordance with aspects of the disclosed embodiment;

FIGS. 8A and 8B are exemplary illustrations of gripper to cap engagement between a sample tube gripper and the cap of the closable tube assemblies described herein, in accordance with aspects of the disclosed embodiment;

FIGS. 9A and 9B are exemplary illustrations of gripper to cap engagement between a sample tube gripper and the cap of the closable tube assemblies described herein, in accordance with aspects of the disclosed embodiment;

FIGS. 10 and 11 are exemplary portions of a cap of the closable tube assembly of FIG. 1, in accordance with aspects of the disclosed embodiment;

FIG. 12 is a schematic block diagram of an exemplary automated sample processing system configured to process the closable tube assemblies described herein, in accordance with aspects of the disclosed embodiment;

FIGS. 13A-13D illustrate engagement between a sample tray and the closable tube assemblies described herein, in accordance with aspects of the disclosed embodiment; and

FIGS. 14, 15, 16, 17, 18, and 19 are flow diagrams of exemplary methods in accordance with the disclosed embodiment.

### DETAILED DESCRIPTION

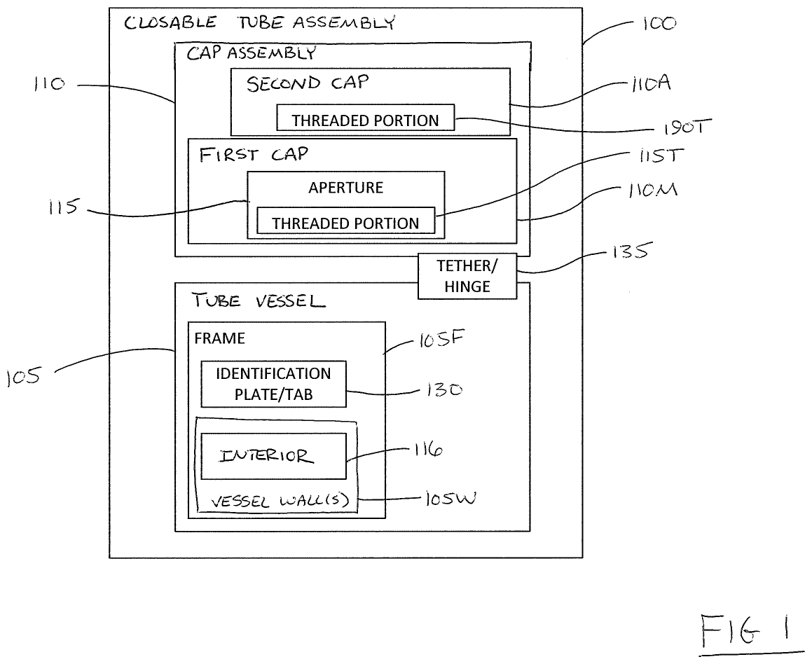

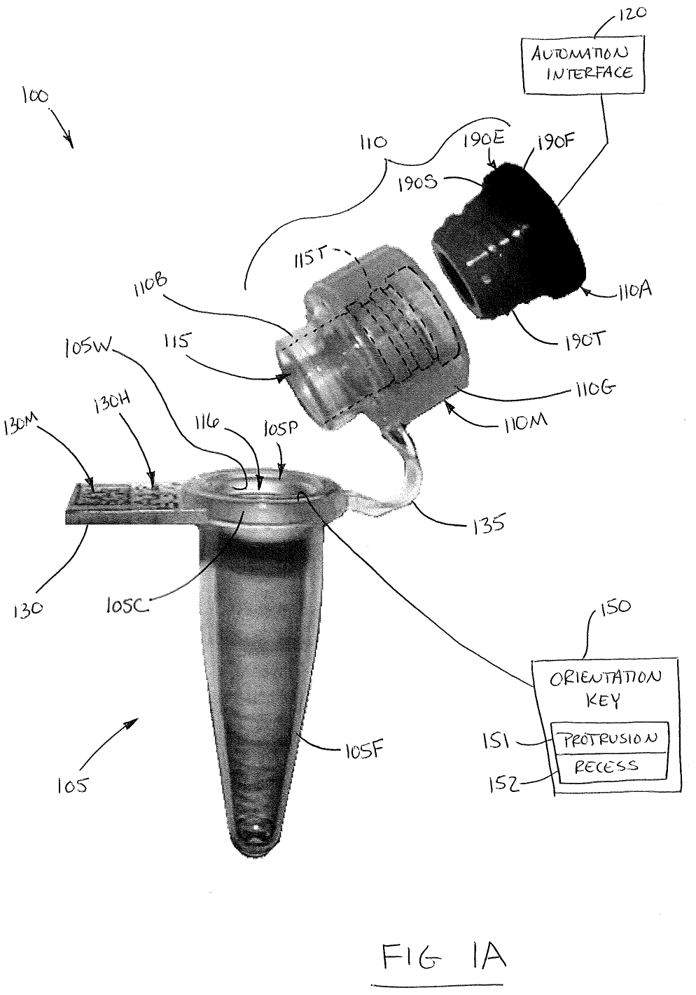

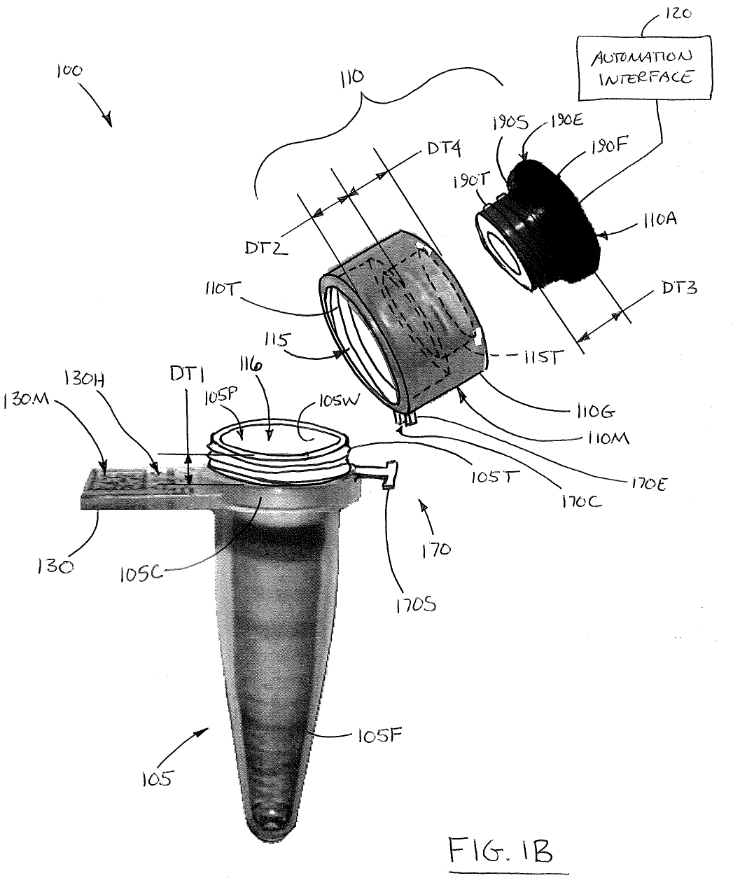

FIG. 1 is a block diagram of an exemplary sample container or closable tube assembly 100 in accordance with aspects of the present disclosure. Although the aspects of the disclosed embodiment will be described with reference to the drawings, it should be understood that the aspects of the disclosed embodiment can be embodied in many forms. In addition, any suitable size, shape or type of elements or materials could be used.

The closable tube assembly 100 generally includes a tube vessel 105 (e.g., a sample holding portion) and a cap assembly or tube closure assembly 110. In some aspects, the cap assembly 110 is tethered or hinged (e.g., with a tether or hinge 135, also referred to herein as a hinge member) to the tube vessel 105; while in other aspects the cap assembly 110 may not be tethered or hinged to the tube vessel 105. The hinge 135 is illustrated as a one-part hinge integral to the tube vessel 105 and cap assembly 110 for exemplary purposes only; however, in other aspects the hinge 135 may be a two-part hinge that is separable from and re-connectable to one or more of cap assembly 110 and tube vessel 105 in any suitable manner.

The tube vessel 105 includes a frame 105F having vessel walls 105W that define an opening 105P to an interior 116 of the tube vessel 105 in which any suitable samples are collected and/or stored (referred to herein as collected for convenience). The frame 105F may also form an identification plate or tab 130 that effects sample identification and/or tracking as described herein. The cap assembly 110 is configured to couple with the tube vessel 105 and seal the interior 116.

The cap assembly 110 includes a first cap 110M (e.g., a manual cap of the cap assembly 110) that is removably connected to the tube vessel 105 over the opening 105P. The first cap 110M is configured, as described herein, to engage an edge of the opening 105P and the tube vessel interior 116 so as to close the opening 105P at least in part with the first cap 110M in a closed position on the tube vessel 105.

The first cap 110M includes an aperture or recess 115 extending there through to provide access through the opening 105P to sample collected in the interior 116 with the first cap 110M coupled to the tube vessel 105. The aperture 115 receives therein the second cap 110A so that each interface between the second cap 110A and an automatic decapping machine (see FIGS. 1A-1C and 2A-11) is recessed within the first cap 110M substantially in entirety.

The cap assembly 110 includes a second cap 110A (e.g., an automatic decapping cap of the cap assembly 110) that is removably connected to the tube vessel 105 and the first cap 110M so that opening 105P closure is commonly effected by both the first cap 110M and the second cap 110A with the first cap 110M in the closed position. The second cap 110A is received within the first cap 110M with the second cap 110A in the closed position. For example, the second cap 110A engages and seals the aperture 115 in the first cap 110M where the second cap 110A includes a threaded portion 190T that engages a corresponding threaded portion 115T of the aperture 115. Removal of the second cap 110A (e.g., from the first cap 110M) opens the opening 105P with the first cap 110M continuously engaged to the edge of the opening 105P substantially maintained (e.g., unmoved) in the closed position on the tube vessel 105. Both the first cap 110M and the second cap 110A have an insert closure configuration relative to the opening 105P, and the second cap 110A has an insert configuration relative to the first cap 110M.

Both the first cap 110M and the second cap 110A have an insert closure configuration relative to the opening 105P, and the second cap 110A has an insert configuration relative to the first cap 110M as illustrated throughout the figures, see for example, at least FIGS. 1A-1C and 2A-3C.

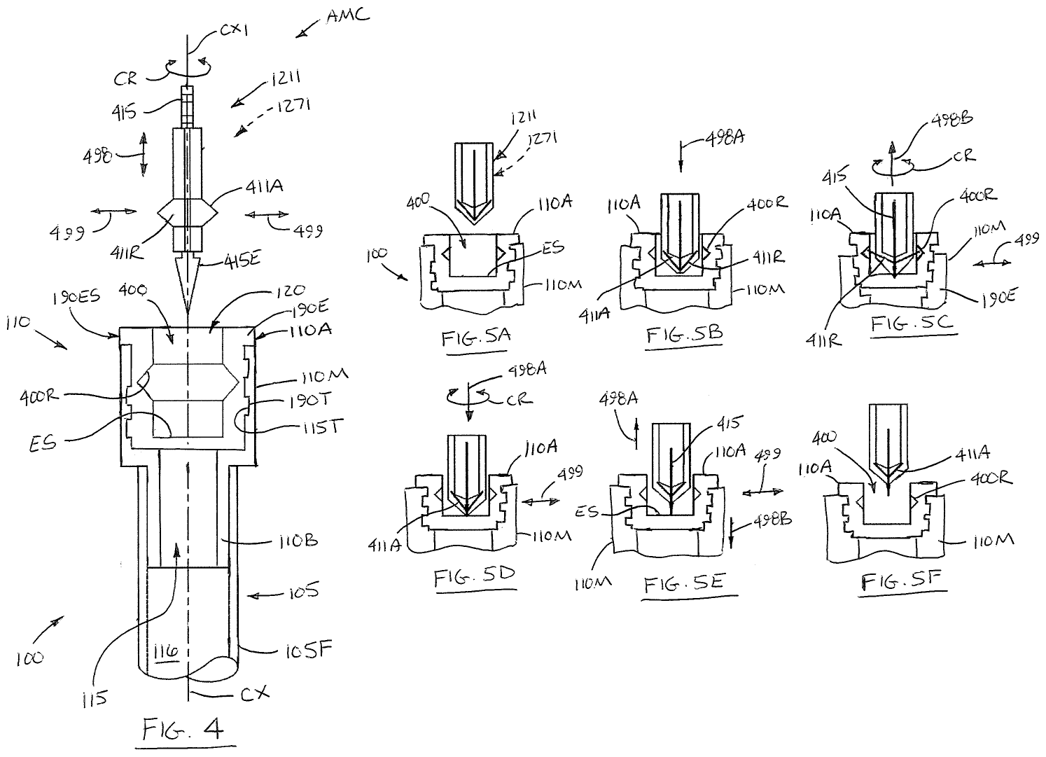

As will be described herein, the second cap 110A has an interface for automatic repeatable engagement with an automatic machine cap opener AMC (also referred to herein as an automatic decapping machine). As will be described herein, the second cap 110A is sized and shaped for automatic repeatable engagement with an automatic decapping machine AMC (as described herein-see FIGS. 4-9B) that automatically decaps the second cap 110A and opens the opening 105P with the first cap 110M staying engaged to the edge of the opening 105P substantially maintained (unmoved) in the closed position on the tube vessel 105. As described herein, each interface between the second cap 110A and the automatic decapping machine AMC effecting decapping automatically is disposed within an outermost perimeter of the manual cap (see FIGS. 1A-1C and 2A-11). The automatic decapping of the second cap 110A decaps the tube vessel 105 and opens the opening 105P.

Referring also to FIGS. 1A-1D, the closable tube assembly 100 is illustrated, for exemplary purposes only, as a 0.2 mL PCR tube (although in other aspects the PCR tube may have any suitable volume capacity such as greater or less than 0.2 mL or at least 0.2 mL; and it should be understood that while PCR tubes are described any suitable container configured for collecting any suitable samples may be employed with the aspects of the disclosed embodiment); however, it should be understood that the aspects of the disclosed embodiment may be employed with any suitable sample tube for holding laboratory samples including, but not limited to, biological samples. As described herein, the closable tube assembly 100 provides for both: manual decapping and capping of the closable tube assembly (e.g., for manual manipulation of a sample held within the closable tube assembly 100); and automated handling (e.g., automated transport, decapping and capping) of the closable tube assembly 100 and the sample held therein. In accordance with aspects of the disclosed embodiment, the cap assembly 110 is a two piece cap that includes the first cap 110M and the second cap 110A. The second cap 110A is received within an aperture 115 of the first cap 110M so as to seal the aperture 115. The second cap 110A is configured with any suitable automation interface 120 (non-limiting examples of which are described herein)) configured to interface with any suitable automation, including but not limited to automated or semi-automated screw cap decappers/cappers and automated sample storage and retrieval system such as those described in U.S. Pat. No. 10,493,457 issued on Dec. 3, 2019, the disclosure of which is incorporated herein by reference in its entirety. The automation interface 120 effects automation repeatable engagement with the automation (e.g., automation machine cap opener or vessel transport) and has a configuration where the fit up and engagement between the second cap 110A and the automation is effected via the automation interface 120 and exclusive of the first cap 110M. The first cap 110M is shaped and sized for gripping by a human hand so as to be manually inserted into or over the closable tube assembly 100 (e.g., to seal the closable tube assembly 100 with the second cap 110A disposed in and sealing the aperture 115) and manually decoupled from the closable tube assembly 100 (e.g., to unseal the closable tube assembly with the second cap 110A disposed in and sealing the aperture 115).

The cap assembly 110, in accordance with the aspects of the disclosed embodiment, enables human users to increase their throughput (the human users may process an increased number closable tube compared assemblies sample containers/tube assemblies that require accessory devices to access the samples therein) as special tools (such accessory devices including tools for interfacing with the automation interface 120) are not required to manually decap and cap the closable tube assembly 100 for inserting and removing sample to and from the closable tube assembly 100. Having a single closable tube assembly 100 that is configured for both manual and automated handling and sample access may reduce consumable usage (e.g., as separate containers are not required for manual handling and automated handling-the closable tube assembly 100 is common to both manual and automated handling).

The aspects of the disclosed embodiment also provide for sample tracking. For example, a tube vessel 105 of the closable tube assembly 100 includes an integral (or inseparable) identification plate or tab 130 on which any suitable machine readable indicia 130M and/or human readable indicia 130H is affixed (e.g., printed, stamped, taped, glued, etc.). The human readable indicia 130H on the closable tube assembly 100 may prevent the human user of the closable tube assembly 100 from needing to write on the closable tube assembly 100 for identification, which may further improving sample tracking by eliminating potential human error. The identification plate 130 is of unitary construction with the tube vessel 105 of the closable tube assembly 100 and may be of the same or a different material as the tube vessel 105.

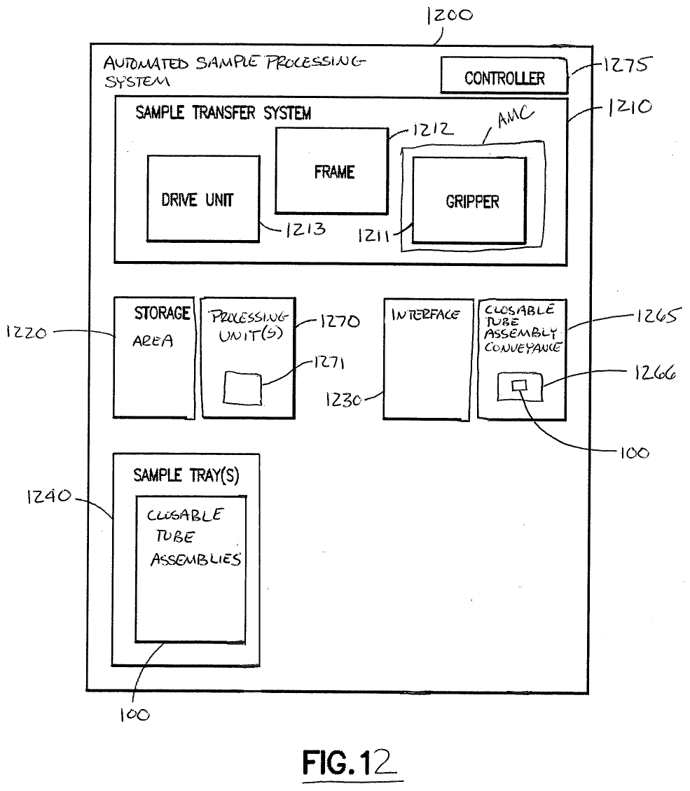

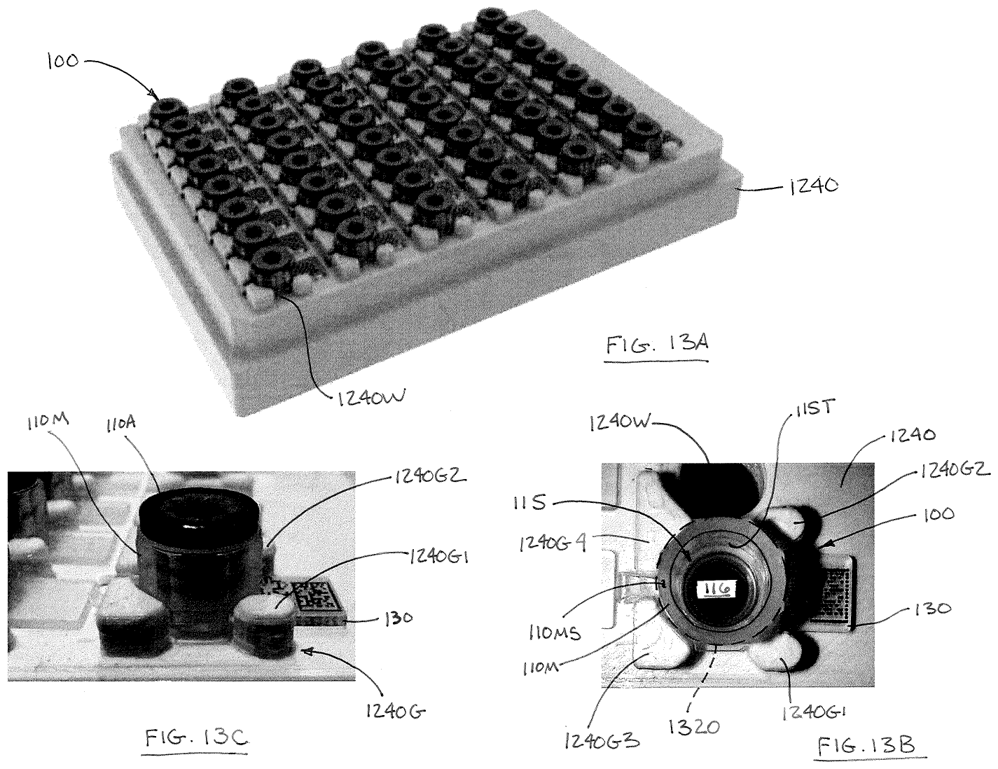

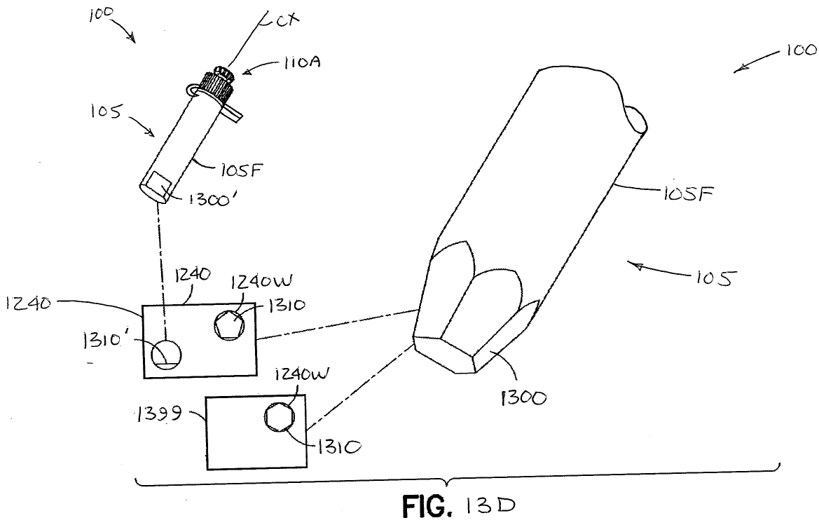

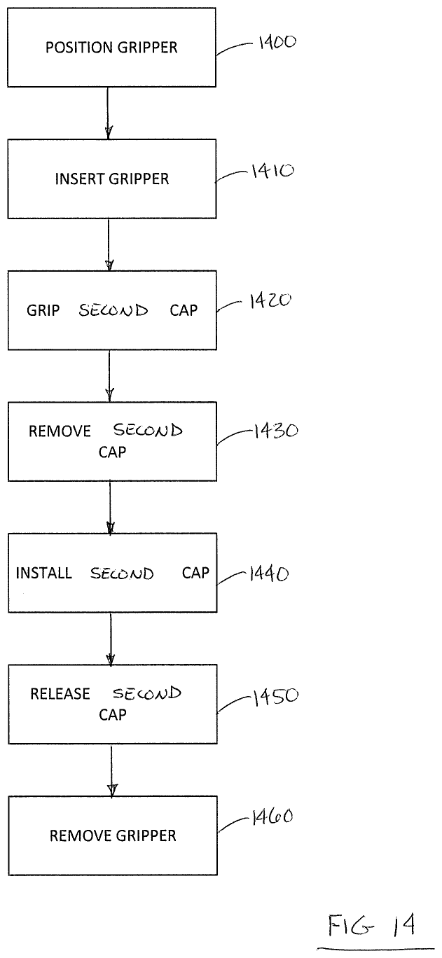

In accordance with aspects of the disclosed embodiment, the closable tube assembly 100 may include more than one tube vessel 105 coupled to each other in a strip of tube vessels 100STR (see FIG. 1E), where each tube vessel 105 in the strip of tube vessels has a respective first cap 110M and a respective second cap 110A removably coupled thereto. In other aspects, the closable tube assembly 100 may be provided as more than one tube vessel 105 disposed in an array (e.g., such as within a tray or storage—see FIGS. 12-13A), where each tube vessel 105 in the array of tube vessels has a respective first cap 110M and a respective second cap 110A removably coupled thereto.

Still referring to FIGS. 1A and 1B, the closable tube assembly 100 includes the cap assembly 110 and tube vessel 105. The tube vessel 105 includes a frame 105F with at least one vessel wall 105W that forms the interior 116. As may be realized, samples are inserted into and collected within the interior 116. As noted above, the cap includes the first cap 110M and the second cap 110A.

The first cap 110M of the cap assembly 110 includes a grip 110G for engaging a hand of a human user. The grip 110G is configured (e.g., shaped and sized) for human gripping of the grip 110G. The grip 110G may have any suitable surface features (knurling, stippling, or other surface roughness) or contour (e.g., hexagonal, octagonal, etc.) that facilitates gripping of the grip portion and effecting insertion and removal of the first cap 110M to and from the tube vessel 105 of the closable tube assembly 100.

The first cap 110M of the cap assembly 110 has a threaded plug closure configuration with respect to the opening 105P, where the threaded plug closure has interior threads or an interior threaded portion 115T disposed so as to engage the second cap 110A inserted into the first cap 110M with the second cap 110A in a closed position on the first cap 110M. The first cap 110M is configured to interface with the tube vessel 105 of the closable tube assembly 100 in any suitable manner such that the cap assembly 110 is retained on the tube vessel 105 through a frictional engagement, a threaded engagement (e.g., male or female threading), a snap engagement, a magnetic engagement, or in any other suitable manner.

In one aspect, as illustrated in FIG. 1A, the cap assembly 110 is configured to engage the edge of the opening 105P and the tube vessel interior 116 as a plug cap and includes a barrel 110B extending from the grip 110G. The barrel 110B is shaped and sized for a friction fit with the at least one vessel wall 105W of the tube vessel 105 so that with insertion of the barrel 110B in the interior 116, the cap assembly 110 is retained securely on the tube vessel 105 and the interior 116 is sealed by the friction fit between the barrel 110B and the at least one vessel wall 105W. The at least one vessel wall 105W and barrel 110B are illustrated, for exemplary purposes, as having cylindrical shapes but in other aspects the vessel wall 105W and barrel 110B may have any suitable complementary shapes (e.g., square, rectangular, triangular, ovoid, etc.) that effect the friction fit.

In other aspects, as illustrated in FIG. 1B, the first cap 110M is configured as a screw cap and includes internal threads 110T within the aperture 115. The internal threads 110T are shaped and sized for engaging external threads 105T of the frame 105F so that with threading of the cap assembly 110 onto the frame 105F, the cap assembly 110 is retained securely on the tube vessel 105 and the interior 116 is sealed by the cap assembly 110. In other aspects, the cap assembly 110 may have external threads and the tube vessel 105 may have internal threads.

In still other aspects, the first cap 110M of the cap assembly 110 and tube vessel 105 may be configured to couple with each other in any suitable manner so that the cap assembly 110 is securely retained on the tube vessel 105. For example, the cap assembly 110 may be configured to “snap” onto the tube vessel and be securely retained on the tube vessel 105 with any suitable resilient members that releasably engage the cap assembly 110, or vice versa.

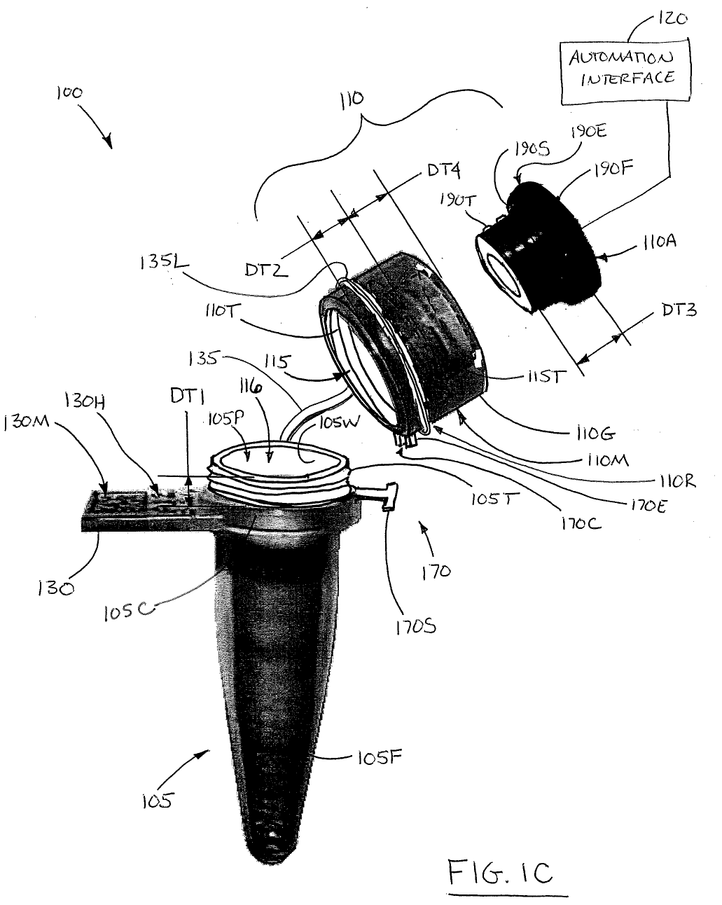

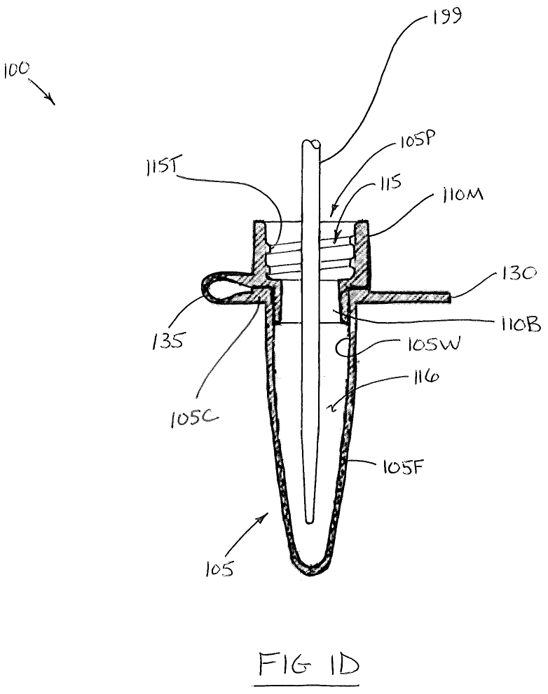

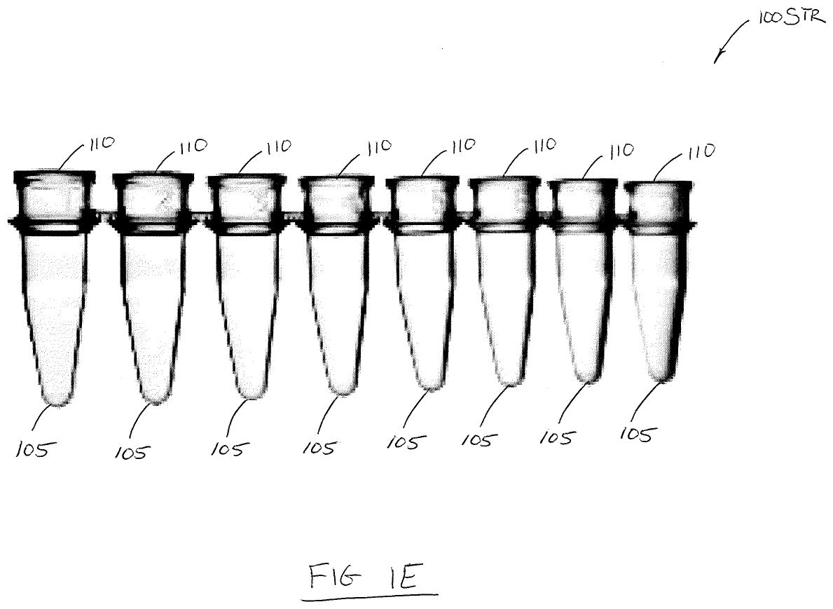

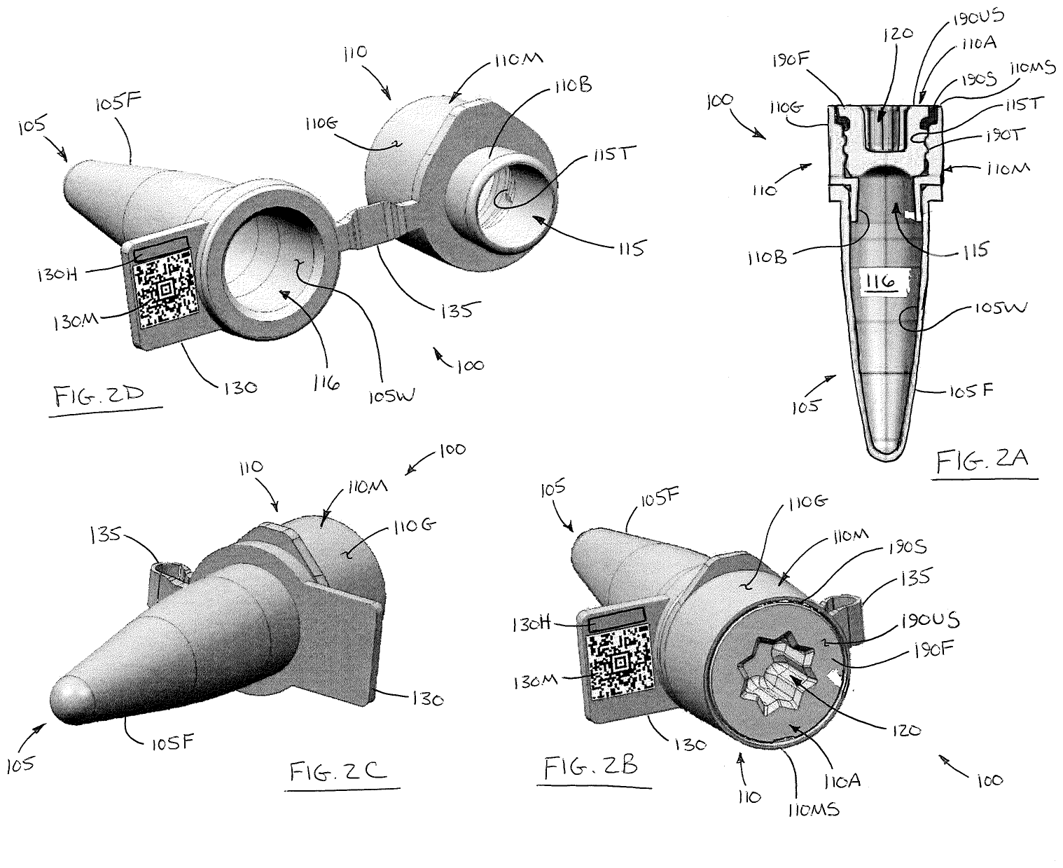

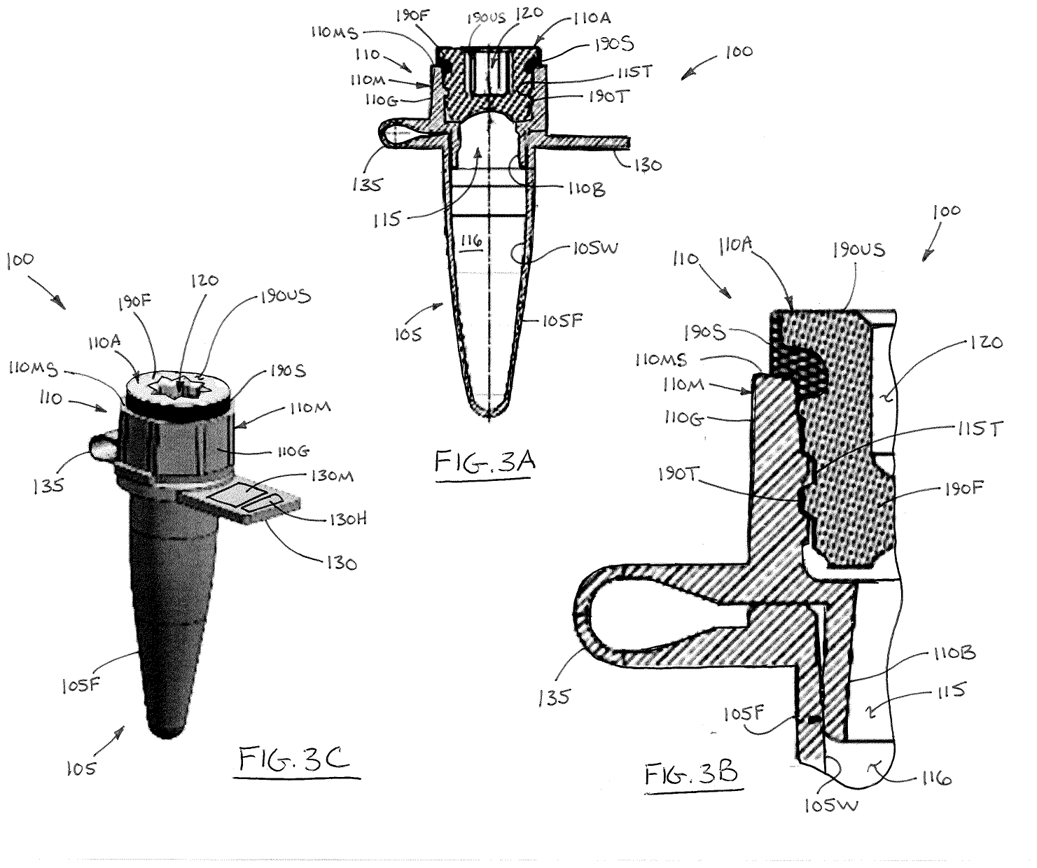

The first cap 110M may be rotationally fixed relative to the tube vessel 105 in any suitable manner. For example, referring again to FIG. 1A, the friction fit between the barrel 110B and the at least one vessel wall 105W may be sufficient to substantially prevent relative rotation of the cap assembly 110 and tube vessel 105 with the cap assembly 110 inserted into the interior 116 of the sample tube holding portion 105. As another example, in addition to or in lieu of the friction fit, the cap assembly 110 is tethered or otherwise hinged to the tube vessel 105 where a tether or hinge 135 substantially prevents relative rotation of the cap assembly 110 relative to the sample tube holding portion 105 with the cap assembly 110 inserted into the interior 116 of the sample tube holding portion 105. The tether or hinge 135 is coupled to both the tube vessel 105 and first cap 110M of the cap assembly 110 so that the cap assembly 110 is retained to tube vessel 105. The hinge 135 hinges the first cap 110M to the tube vessel 105. The hinge 135 hinges both the first cap 110M and the second cap 110A, assembled with each other so as to form a cap in cap assembly (see FIGS. 2A-3C), to the tube vessel 105. In some aspects, the tether or hinge 135 is integrally formed with both the tube vessel 105 and first cap 110M so that the tube vessel 105 and first cap 110M are a single unit.

As another example of rotationally fixing the cap assembly 110 relative to the tube vessel 105 with the cap assembly 110 inserted into the interior 116 of the sample tube holding portion 105, the closable tube assembly 100 includes an orientation key 150 (in addition to or in lieu of the tether or hinge 135) that substantially rotationally fixes the cap assembly 110 relative to the tube vessel 105. Here, the tube vessel 105 includes one of a protrusion 151 or recess 152 and the cap assembly 110 includes another of the protrusion 151 or recess 152 so that with the cap assembly 110 inserted into the interior 116, the protrusion 151 mates with the recess 152 to rotationally lock the cap assembly 110 to the tube vessel 105.

In other aspects, referring to FIG. 1B, the cap may not be tethered or hinged to the tube vessel 105 (or the tether or hinge 135 may provide for rotation of the cap assembly 110 relative to the tube vessel 105 as illustrated in FIG. 1C where the tether or hinge 135 includes a loop 135L that is retained with a circumferential recess 110R of the cap assembly 110 providing rotation of the cap assembly 110 within the loop 135L). Here, the cap may be rotationally fixed relative to the tube vessel 105, with the cap assembly 110 disposed on the tube vessel 105, by a hinged “T” anti-rotation snap coupling 170. For example, the cap includes protrusions that form a channel 170C and engagement surface 170E. The frame 105F includes a flexible or hinged “T” shaped strap member 170S. With the cap assembly 110 threaded onto the tube vessel 105, the channel is aligned with the “T” shaped strap member 170S (e.g., with rotation of the cap assembly 110 relative to the frame 105F). The “T” shaped strap member 170S is folded through the channel 170C to that the “T” shaped strap member 170S engages the engagement surface 170E of the protrusion. Engagement between the “T shaped strap member 170S and the engagement surface 170E maintains the “T” shaped strap member 170S within the channel 170C so as to prevent relative rotation between the cap assembly 110 and the tube vessel 105. In other aspects, the anti-rotation coupling between the cap assembly 110 and tube vessel 105 may have any suitable configuration such as hinged tab (See FIG. 1C). It is noted that the “T” shaped strap member 170S and channel 170C may form a two part hinge, that when coupled flexes to provide a tethered release of the cap assembly 110 from the tube vessel 105. Here, the “T” shaped strap member 170S may have a sufficient length of flexibility/resiliency to provide for the unthreading of the cap assembly 110 from the tube vessel 105.

Still referring to FIGS. 1A, 1B, and 1C, tethered or hinged caps 110 on closable tube assemblies 100 provide for easy, manual access to the interior 116 of the closable tube assembly 100 without requiring accessory devices to remove the caps 110 from the closable tube assemblies 100. The tethered or hinged cap assembly 110 may also prevent loss or displacement of the cap assembly 110 with human handling operations. However, a tethered or hinged cap assembly 110 may not be conducive with automated processing of the samples within the closable tube assemblies 100. Here, the disclosed embodiment provides the cap assembly 110 with a second cap 110A so that closable tube assemblies 100 with tethered or hinged caps 110 are automation friendly. As described herein, the second cap 110A is a secondary or automation engaging cap that is inserted into the aperture 115 of the first cap 110M for sealing the aperture 115. As illustrated in FIG. 1D, the aperture 115 extends completely through the first cap 110M so as to form a passage (with the cap assembly 110 inserted into the interior 116 or threaded onto the frame 105F) through which the interior 116 of the tube vessel 105 of the closable tube assembly 100 can be accessed by any suitable sample handling device 199, such as by pipettes, liquid handlers, etc., for one or more of dispensing samples into the interior 116, removing samples from the interior 116, adding buffers to the interior 116, adding reagents to the interior 116, etc.

Referring also to FIGS. 2A-2D and 3A-3C the second cap 110A includes a frame 190F. The frame 190F includes a threaded portion 190T configured to engage a mating threaded portion 115T of the aperture 115 of the first cap 110M of the cap assembly 110. The second cap 110A also includes an annular seal 190S disposed on the frame 190F, where the annular seal 190S seats against any suitable surface of the aperture 115 and forms a seal between the second cap 110A and the first cap 110M (i.e., sealing the aperture 115). The annular seal 190S may be constructed of any suitable material resilient such material rubber, silicone, as polypropylene, or any other suitable material. In some aspects, the annular seal 190S may be integrally formed with the frame 190F and be of the same material as the frame (e.g., the seal 190S may be formed as a thin (so as to be flexible) resilient seal (having a conical, disc, or any other suitable shape) extending radially from the frame 190F for seating against the first cap 110M and sealing the aperture 115).

As can be seen in the figures and as described herein, the second cap 110A is separate and distinct from the first cap 110M so that the second cap 110A may be removed from and installed on closable tube assembly 100 independent of removal of the first cap 110M of the cap assembly 110 from the tube vessel 105. Here, with the first cap 110M coupled to the tube vessel 105, the second cap 110A may be installed within or removed from the aperture 115 without having to adjust or move the first cap 110M relative to the tube vessel 105. Removal of the second cap 110A (via any suitable automation, examples of which are described herein) provides access to the interior 116 through the aperture 115 of the first cap 110M of the cap assembly 110, which aperture 115 extends completely through the first cap 110M of the cap assembly 110. Installation of the second cap 110A (via the suitable automation or manually) seals the aperture 115 so as to seal the closable tube assembly 100 with the cap assembly 110 coupled to the tube vessel 105.

The first cap 110M may be configured so that the second cap 110A is recessed within the first cap 110M or so that the second cap 110A stands proud (e.g., extends above) of a top surface 110 MS of the first cap 110M. As can be seen in FIGS. 2A and 2B, the aperture 115 of the first cap 110M is shaped and sized to receive the second cap 110A so that a top surface 190US of the second cap 110A is substantially flush or even with the top surface 110 MS of the first cap 110M. Here, the annular seal 190S is disposed between the automation cap frame 190F and the aperture 115 so as to seal with walls of the aperture 115. As can be seen in FIGS. 3A-3C, the aperture 115 of the first cap 110M is shaped and sized to receive substantially only the threaded portion 190T of the second cap 110A so that a portion of the second cap 110A extends above the top surface 110 MS of the first cap 110M (i.e., the top surface 190US of the second cap 110A is above the top surface 110 MS of the first cap 110M). Here, the annular seal 190S is disposed between the automation cap frame 190F and the aperture 115 so as to seal with one or more of walls of the aperture 115 and the top surface 110 MS of the first cap 110M.

As may be realized, the second cap 110A may extend into the aperture 115 by any suitable amount. Still referring to FIGS. 1A and 2A-C, where the cap assembly 110 is a plug cap, the second cap 110A may extend into the aperture 115 so that a sufficient amount of material exists between the barrel 110B and the second cap 110A (e.g., with the second cap 110A installed in the aperture 115) to substantially prevent fatigue/separation of the barrel 110B from the grip 110G. Referring to Fig. Still referring to FIGS. 1B, 2C, where the cap assembly 110 is a threaded cap, the aperture 115 includes the internal threads 110T that extend into the aperture 115 a distance DT2 from a bottom surface of the first cap 110M so as to receive the threads 105T (e.g., having a height DT1 with is less than the distance DT2) of the tube vessel 105. The aperture 115 also includes the threaded portion 115T that extends into the aperture 115 a distance DT4 from a top surface of the first cap 110M so as to receive the threads 190T of the second cap 110A (which have a height DT3 which is less than the distance DT4).

Referring to FIGS. 1A-1C, 2A, 2B, 3A, 3B, 4-11, and 12, and as described above, the second cap 110A includes the automation interface 120. The automation interface 120 facilitates one or more of: automated removal of the second cap 110A from the first cap 110M of the cap assembly 110 and automated transport of the closable tube assembly 100 such as within any suitable automated sample processing system 1200. As an example, referring to FIG. 12, the automated sample processing system 1200 includes one or more of any suitable interface 1230, processing unit(s) 1270, a storage area 1220, and a sample transfer system 1210. In The storage area 1220 may be one or more of a storage array in which samples containers are stored individually or in sample trays 1240, a sample tray 1240, a cart or carriage 1266 of a closable tube assembly conveyance 1265 (that transport closable tube assemblies to and from the automated sample processing system), and any other suitable closable tube assembly holder in which closable tube assemblies 100 may be stored or buffered for sample processing. In some aspects, the storage area 1220 may be configured to maintain samples (e.g., biological samples or any other suitable samples) within the closable tube assemblies 100 in an environment having any suitable temperature such as a room temperature environment, cold environments (e.g., −80° C.), and/or ultra-cold environments (e.g., −150° C.).

The interface 1230 may be configured to allow transfer of closable tube assemblies 100 and/or sample trays 1240 (e.g., holding one or more closable tube assemblies 100) between an external environment outside the automated sample processing system 1200 and an environment within the automated sample processing system 1200. The sample transfer system 1210 is configured to transport closable tube assemblies 100 (e.g., individually or in sample trays 1240) between two or more of the interface 1230, the closable tube assembly conveyance 1265, the storage area 1220, and the processing unit(s) 1270. The sample transfer system 1210 may also be configured to pick and place (e.g., insert and remove) closable tube assemblies 100 from and to sample trays 1240 or the cart or carriage 1266 of the closable tube assembly conveyance 1265. The sample transfer system 1210 may include any suitable frame 1212, a drive unit 1213, and a gripper 1211 movably connected to the frame 1212. The drive unit 1213 may be configured to move the gripper 1211 along one or more axis (e.g., in a horizontal and/or vertical plane) for transporting closable tube assemblies 100 as described herein. The gripper 1211 is configured to engage the automation interface 120 of the second cap 110A, and with engagement of the gripper 1211 with the automation interface 120, one or more of transport the gripped closable tube assembly 100 and remove/install the second cap 110A from/to the closable tube assembly 100 (e.g., unscrew/screw the second cap 110A from/on the first cap 110M of the cap assembly 110).

In some aspect, each processing unit 1270 is configured to interface with the closable tube assembly conveyance 1265 for processing samples within closable tube assemblies 100 held by the cart or carriage 1266 of the closable tube assembly conveyance 1265. Here, the processing unit includes a gripper 1271 configured to at least remove/install the second cap 110A from/to the closable tube assembly 100 (e.g., unscrew/screw the second cap 110A from/on the first cap 110M of the cap assembly 110. In other aspects, the sample transfer system 1210 may transfer the closable tube assemblies 100 (individually or in sample trays 1240) where the gripper 1211 of the sample transfer system 1210 removes/installs the second cap 110A from/on the first cap 110M of the cap assembly 110, or the 1271 gripper of the processing unit 1270 removes/installs the second cap 110A from/on the first cap 110M of the cap assembly 110. The gripper 1271 of the processing unit(s) 1270. As may be realized, the gripper 1271 of the processing unit(s) 1270 is configured to engage the automation interface 120 of the second cap 110A, and with engagement of the gripper 1271 with the automation interface 120, at least remove/install the second cap 110A from/to the closable tube assembly (and in some aspects transfer closable tube assemblies 100 within the respective processing unit 1270).

The automated sample processing system 1200 may include a controller 1275. The controller 1275 is configured (e.g., includes any suitable non-transitory program code) for controlling the operations of the automated sample processing system 1200 so as to effect processing f samples within the closable tube assemblies 100.

Still referring to FIGS. 1A-1C, 2A, 2B, 3A, 3B, and 4-11, the automation interface 120 has any suitable configuration so as to mate (e.g., complementary engagement) with the gripper 1211, 1271 (see FIG. 12). For example, referring to FIGS. 2A, 2B, 3A-3C, and 4, in one aspect the second cap 110A may be configured such that the automation interface 120 is a mechanical interface formed on an interior or inside of the second cap 110A. Here, the automation interface 120 is configured so that any suitable number of gripping members 411A of gripper 1211, 1271 move outwards or away from each other relative to a centerline CX1 of the gripper 1211, 1271 for interfacing with the automation interface 120. For example, the automation interface 120 includes a cavity or recess 400 having an opening in the top surface 190US of the second cap 110A. The cavity 400 may include at least one internal side wall configured to engage the gripper 1211, 1271 such that mechanical forces exerted by the gripper 1211, 1271 on the at least one internal side wall radiate from the longitudinal axis CX1. In one or more aspects, one or more retention features 400R may be located in or on the at least one internal side wall and be configured to positively interface/engage with the gripper 1211, 1271. The one or more retention features 400R are configured to interface with the gripper 1211, 1271 so as to permit rotation of the second cap 110A relative to the first cap 110M of the cap assembly 110. In other aspects, or in combination with the retention features 400R, the second cap 110A includes one or more additional features, for example, a texture or ribbing on a peripheral wall 190E or within the cavity 400, configured to interface with the gripper 1211, 1271 so as to permit rotation of the second cap 110A relative to the first cap 110M of the cap assembly 110.

As can be seen in FIG. 4, the automation interface 120 is disposed within the bounds of the peripheral wall 190E (e.g., does not extend past the edge or side 190ES of the peripheral wall 190E) and as such, the automation interface 120 may be disposed within a perimeter 1320 of a respective closable tube assembly holding area of a sample tray 1240 when the closable tube assembly 100 is disposed within the sample tray 1240 (see FIG. 13B).

The gripper 1211, 1271 may include one or more fingers or gripping members 411A that are moveable in the direction of arrows 499. The gripping members 411A may be constructed of any suitable material such as, for example, stainless steel, carbon fiber, or any other suitable stiff material. In other aspects, the gripping members 411A may be constructed at least partly of any suitable resilient material. The gripping members 411A may include retention features 411R that are configured to engage the retention features 400R of the second cap 110A, e.g., when the gripping members 411A are moved in the direction of arrows 499 (e.g., towards the peripheral wall 190E or away from the longitudinal axis CX of the closable tube assembly 100 where engagement of the retention features 411R with retention features 400R at least in part align the longitudinal axis CX1 of the gripper 1211, 1271 with the longitudinal axis CX of the closable tube assembly 100 (e.g., the interface between the closable tube assembly 100 and the gripper 1211, 1271 is a self-centering interface). Engagement of the retention features 411R with retention features 400R may provide positive gripping of the second cap 110A and closable tube assembly 100 by the gripper 1211, 1271 for transport of the closable tube assembly 100, or with rotation of the gripper 1211 in direction CR removal/installation of the second cap 110A from the first cap 110M of the cap assembly 110. The gripper 1211, 1271 may include an ejector member 415 configured at least in part to disengage the closable tube assembly 100 or second cap 110A from the gripper 1211, 1271. The ejector member 415 may be movable in the direction of arrow 498 relative to the gripping members 411A so that as the gripping members 411A move away from the peripheral wall(s) 190E the ejector member 415 pushes on an ejection surface ES of the cavity 400 so that the closable tube assembly 100 or second cap 110A is moved off of the gripper 1211, 1271 and/or the gripper is lifted out of the cavity 400.

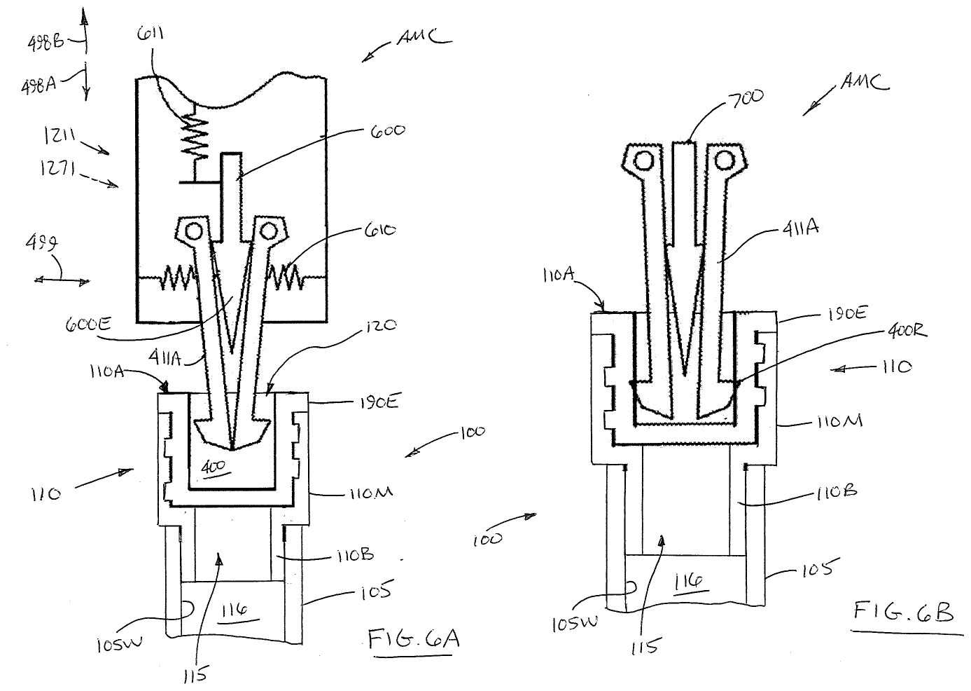

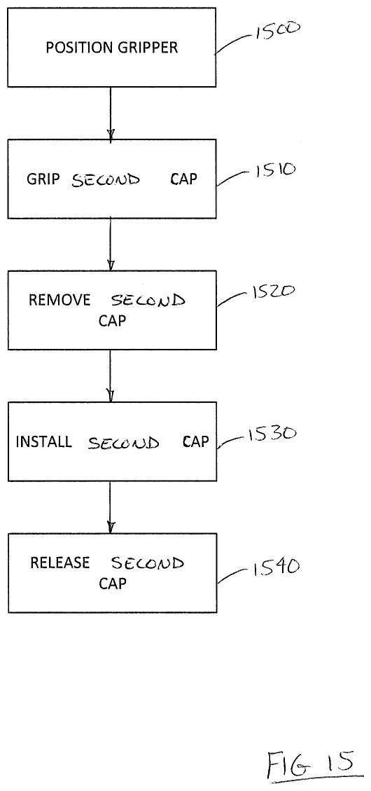

Referring to FIGS. 1A-4, 5A-5F, 12, and FIG. 14 the second cap 110A removal/installation operation from/to the closable tube assembly 100 will be described. The controller 1275 (FIG. 12) may position, using the drive unit 1213, the gripper 1211, 1271 above a predetermined closable tube assembly 100 disposed within, for example, a sample tray 1240 (FIG. 12) or any other suitable closable tube assembly holding area (FIG. 14, Block 1400). The gripper 1211, 1271 is moved in the direction of arrow 498A to position the gripping members 411A within the cavity 400 and to align the retention features 411R of the gripper 1211, 1271 with the retention features 400R of the second cap 110A (FIG. 14, Block 1410). The retention features 411R of the gripper 1211, 1271 may be moved in the direction of arrow 499 towards the peripheral wall(s) 190E of the second cap 110A so that the retention features 411R engage the retention features 400R and the gripper 1211, 1271 grips the second cap 110A (FIG. 14, Block 1420). In one aspect the drive unit 1213 of the sample transfer system 1210 may be configured to extend and retract the gripping members 411A in any suitable manner. In one aspect the ejector member 415 may be employed to extend and retract the gripping members 411A. For example, the ejector member 415 may be biased (in any suitable manner such as by a resilient member) in the direction of arrow 498B and the gripping members 411A may be biased (in any suitable manner such as by resilient member) in a retracted or non-extended position. The ejector member 415 may include an extender portion 415E that when positioned between the gripping members 411A causes the extension or spreading of the gripping members 411A in the direction of arrow 499. As may be realized, the bias of the ejector member 415 in the direction of arrow 498B (in a manner similar to that described with respect to FIGS. 6A and 6B) may position the extender portion 415E relative the gripping members 411A so that the gripping members are in the extended position so as to retain the second cap 110A (and where a closable tube assembly 100 is being transferred, the closable tube assembly 100 coupled to the second cap 110A) gripped thereby in the event of a power failure. In still other aspects the gripping members 411A may be opened and closed by a respective portion of the drive unit 1213 configured to move each of the gripping members in the direction of arrow 499 independent of the ejector member 415. Once the second cap 110A is gripped by the gripper 1211, 1271 the controller 1275 may cause, using the drive unit 1213, rotation of the gripper 1211, 1271 in direction CR with simultaneous movement of the gripper 1211, 1271 in direction 498B so that the second cap 110A is unscrewed and removed from the first cap 110M of the cap assembly 110 (FIG. 14, Block 1430). To reinstall the second cap 110A, the second cap 110A may be positioned over the aperture 115 of the first cap 110M of the cap assembly 110, where the gripper is moved, such as by the drive unit 1213, simultaneously in the rotation direction CR and in direction 498A to screw the second cap 110A into the aperture 115 and install the second cap 110A to the first cap 110M of the cap assembly 110 (FIG. 14, Block 1440). The drive unit 1213 may effect relative movement of the ejector member 415 and the gripping members 411A so that the ejector member 415 is moved in the direction of arrow 498A while the gripping members 411A are moved in the direction of arrow 498B to open the gripping members 411A and release the second cap 110A (FIG. 14, Block 1450). In other aspects the ejector member 415 may be held stationary against the ejection surface ES while the gripping members 411A are moved in the direction of arrow 498B to open the gripping members 411A and release the second cap 110A. As may be realized, the relative movement of the gripping members 411A and the ejector member 415 causes movement of the gripping members 411A in the direction of arrow 499 away from the peripheral wall(s) 190E to release the retention members 411R from the retention members 400R. As the gripping members 411A (and the gripper 1211, 1271) are removed from cavity 400 (FIG. 14, Block 1460) the ejector member 415 may hold the second cap 110A (and the closable tube assembly 100) within the sample holding area or otherwise move the second cap 110A (and closable tube assembly 100) off of the gripper 1211, 1271.

Referring to FIGS. 6A-6B, in one aspect, the actuation of the gripping members 411A may be independent of the ejector member 415 or where an ejector member 415 is not provided. For example, a transmission member 600 may be connected to the drive unit 1213 for movement in the direction of arrows 498A, 498B. The transmission member 600 may include an extender portion 600E, substantially similar to extender portion 415E described above, such that when the transmission member 600 is moved in the direction of arrow 498A to a position between the gripping members 411A the gripping members 411A are moved, by the extender portion 600E, in the direction of arrow 499 to engage the retention features 400R of the second cap 110A in a manner substantially similar to that described above. As may be realized, the second cap 110A (and closable tube assembly 100) may be released from the gripper 1211, 1271 by moving the transmission member 600 in the direction of arrow 498B relative to the gripping members 411A (which may be biased in a retracted position) so that the gripping members move away from the peripheral wall(s) 190E of the second cap 110A in a manner substantially similar to that described above. The gripping members 411A may be biased in a retracted position in any suitable manner such as by a resilient member 610 and the transmission member 600 may be biased in the direction of arrow 498A by any suitable resilient member 611 so that the transmission member causes extension of the gripping members 411A and the gripping members are extended or remain extended in the event of a power failure so that any second cap 110A or closable tube assembly 100 held by the gripper 1211, 1271 remains held by the gripper 1211, 1271.

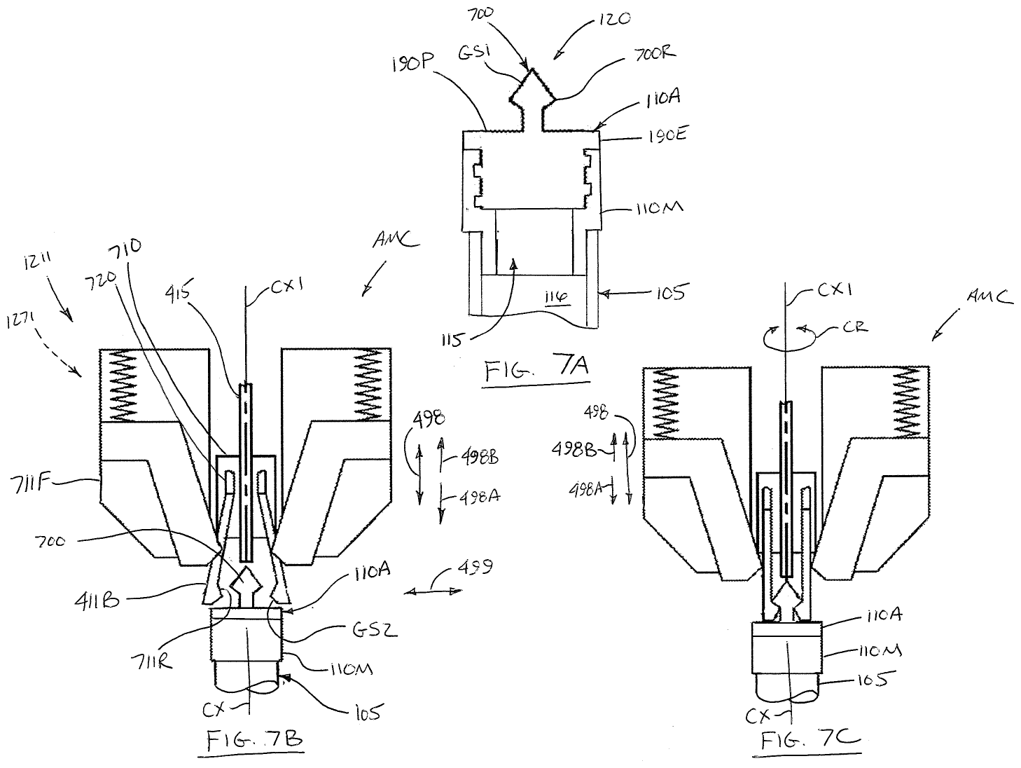

Referring now to FIGS. 7A-7C, in one aspect the second cap 110A may be configured such that the automation interface 120 is a mechanical interface formed on an exterior or surface 190P of the second cap 110A. In this aspect the surface 190P is a top surface of the second cap 110A (e.g. a surface disposed opposite the tube vessel 105). Here the automation interface 120 is configured so that any suitable number of gripping members 411B of gripper 1211, 1271 move inwards or towards each other relative to a centerline CX1 (FIG. 7B) of the gripper 1211, 1271 for interfacing with the automation interface 120 (see FIGS. 7B and 7C). For example, automation interface 120 includes a protrusion 700 extending from the surface 190P of the second cap 110A. The protrusion 700 may include one or more retention features 700R configured to positively interface with the gripper 1211, 1271. The retention features 700R and/or the gripper members 411B may include guide surfaces GS1, GS2 which may provide self-alignment between the gripping members 411B and the protrusion 700 as the gripping members 411B are moved over/past the retention features 700R when picking the closable tube assembly 100 for transport or removing the second cap 110A from the first cap 110M of the cap assembly 110 (e.g. for engaging the protrusion 700). One or more of the retention features 700R are configured to interface with the gripper 121, 1271 so as to permit rotation of the second cap 110A relative to the tube vessel 105 and the first cap 110M of the cap assembly 110. In other aspects the second cap 110A contains one or more additional features, for example, a texture or ribbing on the peripheral wall 190E or on protrusion 700, configured to interface with the gripper 1211, 1271 so as to permit rotation of the second cap 110A relative to the tube vessel 105 and first cap 110M (e.g., in a manner similar to that described above with respect to FIGS. 5A-5F).

As can be seen in FIG. 7A, the automation interface 120 is disposed within the bounds of the peripheral wall 190E (e.g. does not extend past the edge or side 190ES the peripheral wall 190E) and as such, the automation interface 120 is disposed within the perimeter 1320 of a respective closable tube assembly holding area of the sample tray 1240 when the closable tube assembly 100 is disposed within the sample tray 1240.

Referring also to FIGS. 7B and 7C, the gripper 1211, 1271 may include one or more fingers or gripping members 411B that are moveable in the direction of arrow 499. The gripping members 411B may include retention features 711R that are configured to engage retention features 700R of the second cap 110A, e.g. when the gripping members 411B are moved in the direction of arrows 499 (e.g. away from the peripheral wall(s) 190E towards the longitudinal axis CX of the closable tube assembly 100—see FIG. 7C). Engagement of the retention features 711R with retention features 700R may, at least in part, align the longitudinal axis CX1 of the gripper 1211, 1271 with the longitudinal axis CX of the closable tube assembly 100 (e.g. the interface between the closable tube assembly and the gripper is a self-centering interface). Engagement of the retention features 711R with retention features 700R may also provide positive gripping of the second cap 110A by the gripper 1211, 1271 (e.g., for removal of the second cap 110A from the closable tube assembly 100) or positive gripping of the second cap 110A by the gripper 1211, 1271 (e.g., for transport of the closable tube assembly 100).

The gripper 1211, 1271 may include an ejector member 415 configured at least in part to disengage the second cap 110A from the gripper 1211, 1271 in a manner substantially similar to that described above. As described above, the ejector member 415 may be movable in the direction of arrow 498 relative to the gripping members 411B so that the as the gripping members 411B move towards the peripheral wall(s) 190E, the ejector member 415 pushes on the protrusion 700R so that the second cap 110A is moved off of the gripper 1211, 1271 and/or the gripper 1211, 1271 is lifted from the second cap 110A. In one aspect, the gripping members 411B may be opened and closed in a manner substantially similar to that described above with respect to gripping members 411A while in other aspects the gripping members 411B may be opened and closed in any suitable manner. In still other aspects, the gripping members 411B may be opened and closed by a respective portion of the drive unit 1213 configured to move each of the gripping members in the direction of arrow 499 independent of the ejector member 415 (such as in a manner similar to that described herein with respect to FIG. 6A and 6B).

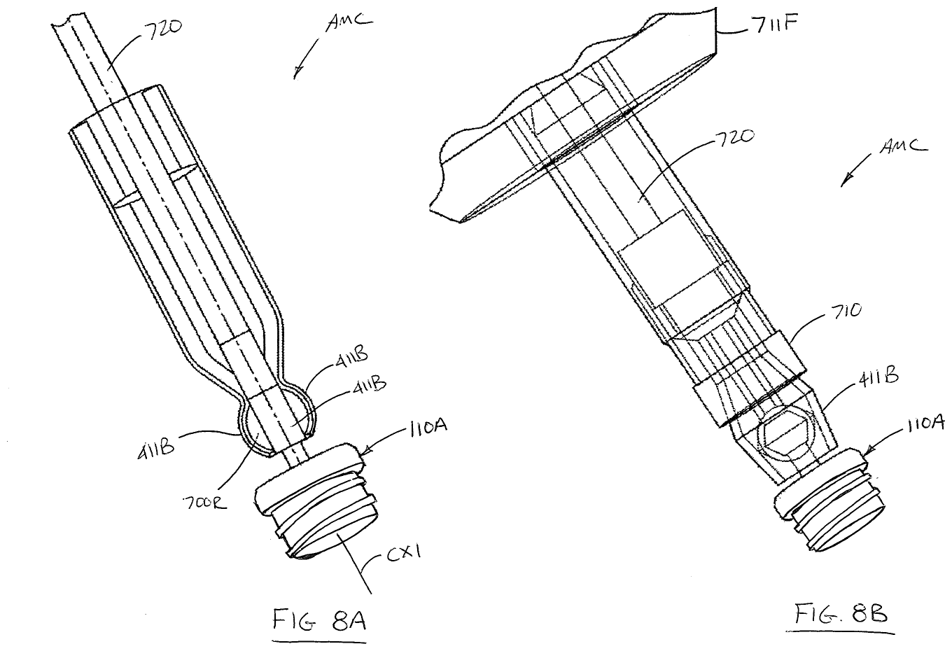

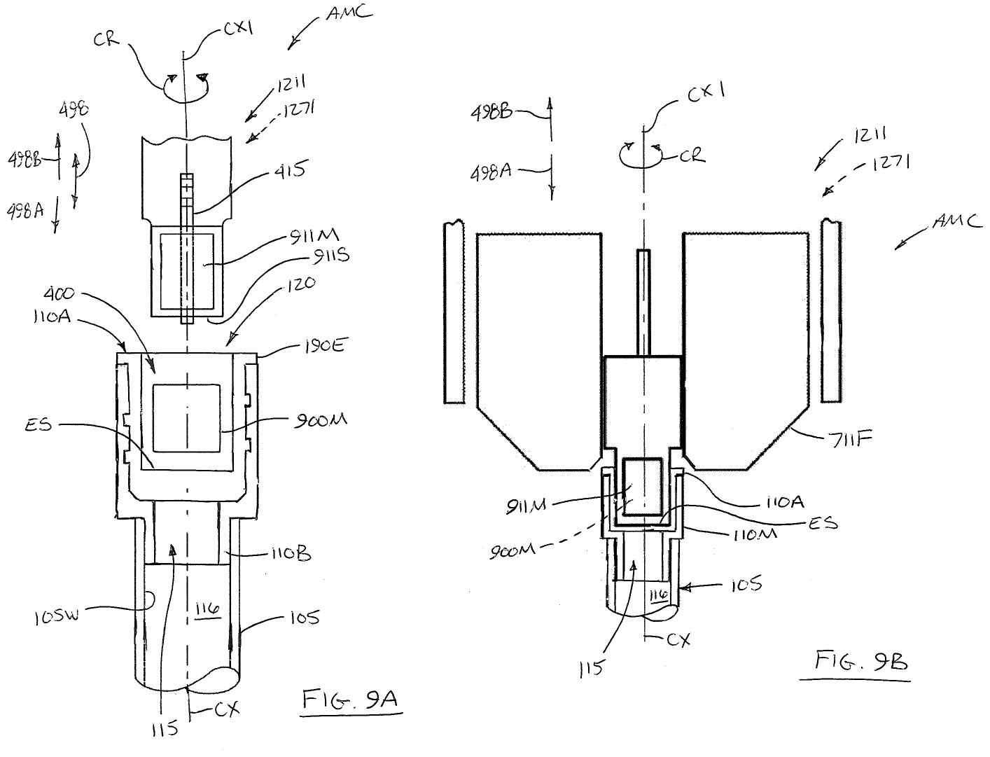

Still referring to FIGS. 7A-7C and also to FIGS. 8A and 8B, the gripper 1211, 1271 includes a frame 711F to which the gripping members 411B and the ejector member 415 are connected. In one aspect, the gripping members 411B may have a dual bias. For example, at least a portion of the gripping members 411B may be resilient where the gripping members 411B extend or otherwise depend from a body 720. The gripping members 411B may be biased away from each other (e.g. in an open position) such that the gripping members 411B are spread apart or otherwise extend away from the longitudinal axis CX1 of the gripper 1211, 1271. In one aspect, the body 720 may be movable relative to a grip tube 710 that is connected to the frame 711F and through which the body 720 passes, where the body 720 may be biased in the direction of arrow 498B so that the gripping members 411B are pulled at least partially into the grip tube 710 for closing the gripping members 411B. An interaction between the gripping members 411B and the grip tube 710 as the body 720 is moved in the direction of arrow 498B causes the gripping members 411B to move towards each other (e.g. towards the longitudinal axis CX1 to place the gripping members in a gripping position) for gripping the second cap 110A. As may be realized, the interaction between the gripping members 411B and the grip tube 710 as the body 720 is moved in the direction of arrow 498A causes the gripping members 411B to move away from each other (e.g. away from the longitudinal axis CX1 to place the gripping members in an open or un-gripped position) for allowing the gripping members 411B to pass over the retention features 700R for picking and placing the closable tube assembly 100 for transport or for removing the second cap 110A from the closable tube assembly 100. In another aspect, the grip tube 710 may be movable relative to the body 720 where the grip tube 710 may be biased in the direction of arrow 498A for holding the gripping members 411B in the gripping position and for opening the gripping members 411B when the grip tube is moved in the direction of arrow 498B. In other aspects the body 720 (and hence the gripping members 411B) and the grip tube 720 may be movable relative to each other. As may be realized, the bias of the grip tube 710 and/or gripping members 411B may hold the gripping members 411B in a closed position in the event of, for example, a power failure so that a closable tube assembly 100 or second cap 110A held by the gripper 1211, 1271 remains held by the gripper 1211, 1271. In another aspect, the gripper 1211, 1271 may not include the grip tube 710 and gripping members 411B may be opened or otherwise spread apart using an ejector member 415 in a manner substantially similar to that described above, where the ejector member passes between the gripping members 411B to spread or otherwise open the gripping members 411B.

Referring to FIGS. 1A-4, 7A-8B, 12, and FIG. 15 and second cap 110A removal/installation operation from/to the closable tube assembly 100 will be described. The controller 1275 (FIG. 12) may position, using the drive unit 1213, the gripper 1211, 1271 above a predetermined closable tube assembly 100 disposed within, for example, a sample tray 1240 (FIG. 12) or any other suitable closable tube assembly holding area (FIG. 15, Block 1500). The gripper 1211, 1271 is moved in the direction of arrow 498A to position the gripping members 411B over the protrusion 700 and to align the retention features 711R of the gripper 1211, 1271 with the retention features 700R of the second cap 110A. The retention features 711R of the gripper 1211, 1271 may be moved in the direction of arrow 499 away from the peripheral wall(s) 190E of the second cap 110A (e.g., towards the longitudinal axis CX1) so that the retention features 711R engage the retention features 700R and the gripper 1211, 1271 grips the second cap 110A (FIG. 15, Block 1510). In one aspect the drive unit 1213 of the sample transfer system 1210 may be configured to extend and retract the gripping members 411B in any suitable manner, such as that described above. Once the second cap 110A is gripped by the gripper 1211, 1271 the controller 1275 may cause, using the drive unit 1213, rotation of the gripper 1211, 1271 in direction CR with simultaneous movement of the gripper 1211, 1271 in direction 498B so that the second cap 110A is unscrewed and removed from the first cap 110M of the cap assembly 110 (FIG. 15, Block 1520). To reinstall the second cap 110A, the second cap 110A may be positioned over the aperture 115 of the first cap 110M of the cap assembly 110, where the gripper is moved, such as by the drive unit 1213, simultaneously in the rotation direction CR and in direction 498A to screw the second cap 110A into the aperture 115 and install the second cap 110A to the first cap 110M of the cap assembly 110 (FIG. 15, Block 1530). The drive unit 1213 may effect relative movement of the ejector member 415 and the gripping members 411B so that the ejector member 415 is moved in the direction of arrow 498A while the gripping members 411B are moved in the direction of arrow 498B to open the gripping members 411A and release the second cap 110A (FIG. 15, Block 1540). In other aspects the ejector member 415 may be held stationary against the protrusion 700 while the gripping members 411B are moved in the direction of arrow 498B to open the gripping members 411B and release the second cap 110A. As may be realized, the relative movement of the gripping members 411B and the ejector member 415 causes movement of the gripping members 411B in the direction of arrow 499 towards the peripheral wall(s) 190E (e.g., away from the longitudinal axis CX1) to release the retention members 711R from the retention members 700R. As the gripping members 411B (and the gripper 1211, 1271) are moved away from the protrusion 700 the ejector member 415 may hold the second cap 110A (and the closable tube assembly 100) within the sample holding area or otherwise move the second cap 110A (and closable tube assembly 100) off of the gripper 1211, 1271.

Referring now to FIGS. 9A and 9B, in one aspect the gripper 1211, 1271 and the automation interface 120 may be configured to magnetically interact with one another and reduce the number of moving parts in the gripper 1211, 1271. For example, the second cap 110A in this aspect has an automation interface 120 configured to magnetically interact with the gripper 1211, 1271. For example, the automation interface 120 may include a magnetic gripping member 900M which may be any suitable ferrous material such as a permanent magnet that forms at least a portion of the internal side wall of the cavity 400 and/or is disposed at least partly within the peripheral wall 190E. The gripper 1211, 1271, which may be substantially similar to the grippers described above, may include (e.g. instead of gripping members 411A, 411B) a magnetic gripping member 911M that is shaped and sized so that the magnetic gripping member 911M fits at least partly within the cavity 400 (see FIG. 9B).

In one aspect the magnetic gripping member 911M may be a permanent magnet that magnetically couples with the magnetic gripping member 900M for magnetically gripping the second cap 110A. In some aspects, the magnetic coupling between the magnetic gripping members 911M, 900M may be strong enough to facilitate rotation of the second cap 110A relative the first cap 110M of the cap assembly 110; while in other aspects, the gripper 1211, 1271 includes splines (or other engagement features) that engage with mating splines (or other mating engagement features) of the cavity 400 to rotationally fix the gripper 1211, 1271 and the second cap 110A to facilitate the rotation of the second cap 110A relative the first cap 110M of the cap assembly 110.

Here the ejector member 415 may be employed to push against the ejection surface ES to disengage the magnetic gripping members 900M, 911M from each other during placement of the closable tube assembly 100 or during installation of the second cap 110A to the first cap 110M of the cap assembly 110. In another aspect the magnetic gripping member 911M may be an electromagnet having one or more electromagnetic coils or electrical windings which may be under the control of controller 170 or any other suitable controller. Here the magnetic gripping member 911M, when activated, may generate an electromagnetic field that produces a motive force in the direction of arrow 498B which may cause, through interaction with the magnetic gripping member 900M, the closable tube assembly 100 or second cap 110A to move in the direction of arrow 498B towards the gripper 1211, 1271 until, for example, the ejection surface ES contacts the ejection member 415 and/or a surface 911S (such as a bottom surface) of the gripper 1211, 1271. In one aspect the ejection member 415 may not be provided as sufficient clearance may be provided between the gripper 1211, 1271 and the cavity 400 so that when the magnetic gripping member 911M is turned off or deactivated (or if a direction of the magnetic field is reversed so that the motive force provided by the gripping member 900M is in the direction of arrow 498A as described below) the gripper 1211, 1271 is freely movable relative to the cavity 400 for releasing the second cap 110A from the gripper 1211, 1271.

In other aspects the ejection member 415 may not be provided as the magnetic gripping member 911M may be configured to produce, when energized with differing polarities, magnetic forces in the direction of arrow 498B as well as forces in the direction of arrow 498A. For example, when picking a closable tube assembly 100 or removing the second cap 110A from the closable tube assembly 100, the magnetic gripping member 911M may be activated to produce magnetic gripping forces in the direction of arrow 498B for gripping and lifting at least the second cap 110A. When installing the second cap 110A or placing a closable tube assembly 100, the magnetic gripping member 911M may be activated to produce magnetic gripping forces in the direction of arrow 498A for releasing at least the second cap 110A. As may be realized, in one aspect, the magnetic gripping member 911M may be controlled by, for example the controller 170 so that a rate of movement of the closable tube assembly caused by the electromagnetic forces of the magnetic gripping member 911M can be controlled in any suitable manner.

Referring to FIGS. 9A, 9B, and 14 the operation of gripper 1211, 1271 (having a magnetic grip configuration) may be substantially similar to the operation of gripper 1211, 1271 described above. For example, the controller 170 may position, using the drive unit 1213, the gripper 1211, 1271 above a predetermined closable tube assembly 100 disposed within, for example, a sample tray 1240 or any other suitable closable tube assembly holding area (FIG. 14, Block 1400). The gripper 1211, 1271 is moved in the direction of arrow 498A to position the magnetic gripping member 911M within the cavity 400 (FIG. 14, Block 1410). The magnetic gripping member 911M of the gripper 1211, 1271 magnetically interacts with the magnetic gripping member 900M of the second cap 110A for gripping the second cap 110A (FIG. 14, Block 1420). As described above, in one aspect the gripping may be a passive gripping such as when magnetic gripping member 911M is a permanent magnet or an active gripping such as when the magnetic gripping member 911M is an electromagnet. The magnetic gripping members 900M, 911M may be arranged so that attractive magnetic forces between the magnetic gripping members 900M, 911M provide self-centering forces for aligning the longitudinal axis CX of the closable tube assembly 100 (and of the second cap 110A) with the longitudinal axis CX1 of the gripper 1211, 1271. Once the second cap 110A is gripped by the gripper 1211, 1271 the controller 170 may cause, using the drive unit 1213, removal of the second cap 110A from the closable tube assembly 100 (FIG. 14, Block 1430) or the closable tube assembly 100 to be picked from the closable tube assembly holding area for transport. Where the automation cap is removed, the gripper 1211, 1271 is rotated in direction CR substantially simultaneously with movement of the gripper 1211, 1271 in direction 498B to unscrew the second cap 110A from the closable tube assembly 100. To reinstall the second cap 110A, the second cap 110A may be positioned over the aperture 115 of the first cap 110M of predetermined closable tube assembly 100 where the gripper 1211, 1271 moves in direction 198A substantially simultaneously with rotation in direction CR to screw the second cap 110A into the aperture 115 of the first cap 110M of the closable tube assembly 100 (FIG. 14, Block 1440). The gripper 1211, 1271 may release the second cap 110A (FIG. 14, Block 1450) and be removed from the cavity 400 (FIG. 14, Block 1460). For example, where the gripping is a passive gripping, the drive unit 1213 may effect relative movement of the ejector member 415 and the magnetic gripping member 911M so that the ejector member 415 is moved in the direction of arrow 498A against the ejection surface ES while the magnetic gripping member 911M is moved in the direction of arrow 498B to remove the magnetic gripping member 911M from the cavity 400 and release the second cap 110A from the gripper 1211, 1271. In other aspects the ejector member 415 may be held stationary against the ejection surface ES (e.g., when the closable tube assembly 100 is within a holding area) while the magnetic gripping member 911M is moved in the direction of arrow 498B out of the cavity 400 to release the second cap 110A from the gripper 1211, 1271. In other aspects, where the gripping is an active gripping, the electromagnet may be turned off or the electromagnetic field may be reversed as described above to release the second cap 110A from the gripper 1211, 1271.

Referring to FIGS. 1A-1D, 10, and 11 in one aspect, in a manner similar to that described above the automation cap 120 includes the protrusion 700 that extends from surface 190P of the second cap 110A where the protrusion includes one or more retention features 700R configured to positively interface with the grippers 1211, 1271 described herein. In this aspect, the protrusion 700 also includes a cavity 400 substantially similar to that described herein where the protrusion 700 provides for the gripping and transport of at least the second cap 110A (and the tube vessel 105 where transport of the closable tube assembly 100 is desired) and the cavity 400 provides for rotation and removal of the second cap 110A from the first cap 110M of the cap assembly 110. Here the cavity 400 is configured to engage the grippers 1211, 1271 described herein. In one aspect, as illustrated in FIG. 11 the cavity 400 includes a peripheral wall or surface 400S on which one or more grip members 1100A are located. In one aspect the one or more grip members 1100A protrude from surface 400S towards a centerline CX of the second cap 110A. In other aspects, the grip members 1100A have any suitable configuration that allows the second cap 110A to be gripped by the gripper 1211, 1271 and removed from or installed on closable tube assembly 100 (e.g., the first cap 110M) through a rotation of the second cap 110A relative to the closable tube assembly 100 (e.g. to unscrew or screw the second cap 110A to/from the first cap 110M). In one aspect the peripheral wall 400S of the cavity 400 may have any suitable geometric shape (square, triangular, slotted, pentagonal, hexagonal, octagonal, etc.) that provides for at least a rotationally coupled engagement between the second cap 110A and the gripper 1211, 1271. In other aspects, the grip members 1100A include magnets, similar to that described herein with respect to FIGS. 9A and 9B, where the magnets are arranged relative to the cavity 400 for at least rotationally coupling the second cap 110A with the gripper 1211, 1271. While the one or more grip members 1100A are illustrated with respect to second cap 110A it should be understood that the grip members 1100A may be included within the cavities 400 of the other caps described herein (e.g. that do not include a protrusion 700) in combination with the retention features (e.g. such as retention features 400R) so that the cavity 400 provides for both transport of the closable tube assembly 100 or second cap 110A and removal of the second cap 110A from the closable tube assembly 100.

The grip members 1100A are, in one aspect, configured for a passive engagement with the gripper 1211, 1271. For example, the grip members 1100A are configured to allow insertion of the gripper 1211, 1271 into the cavity 400 and rotationally engage the gripper 1211, 1271 substantially without radial or rotational movement of the gripper 1211, 1271 relative to the grip members 1100A that would otherwise cause an active gripping or engagement of the grip members 1100A. In other aspects, the grip members 1100A are configured for an active engagement with the gripper 1211, 1271 such that when inserted into the cavity 400, the gripper 1211, 1271 moves radially outward to actively engage the grip members 1100A in a manner substantially similar to that described herein with respect to engagement of the retention features 400R. In other aspects, the grip members 1100A are configured for active engagement with the gripper 1211, 1271 through at least a partial rotation of the gripper 1211, 1271 relative to the grip members 1100A in any suitable manner.

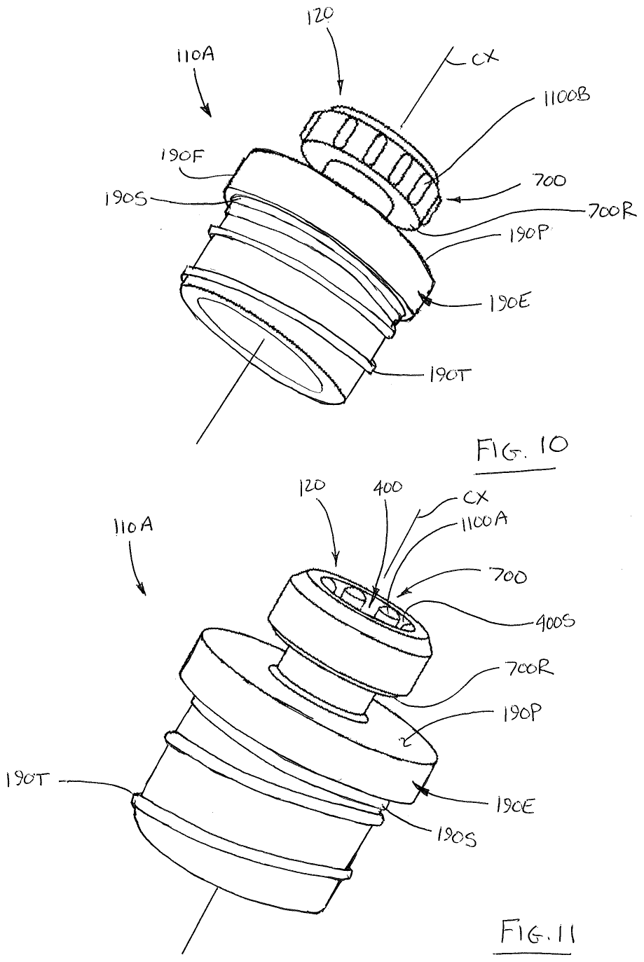

Referring to FIG. 10, the second cap 110A is substantially similar to that illustrated in FIG. 11 however, in this aspect the grip members 1100B are disposed on a peripheral surface of the protrusion 700 so as to extend outward from the centerline CX of the second cap 110A. In this aspect, the grip members 1100B have any suitable configuration that allows the second cap 110A to be gripped by a gripper 1211, 1271 and removed from or installed on the closable tube assembly 100 (e.g., the first cap 110M) through a rotation of the second cap 110A relative to the closable tube assembly 100 (e.g. to unscrew or screw the cap to/from the first cap 110M). In one aspect the peripheral wall of the protrusion 700 may have any suitable geometric shape (square, triangular, slotted, pentagonal, hexagonal, octagonal, etc.) that provides for at least a rotationally coupled engagement between the second cap 110A and the gripper 1211, 1271. In other aspects, the grip members 1100B include magnets, similar to that described herein with respect to FIGS. 9A and 9B (but disposed around the periphery of the external surface of protrusion 700 rather than around a periphery of the internal cavity 400), where the magnets are arranged relative to the protrusion 700 for at least rotationally coupling the second cap 110A with the gripper 1211, 1271. While the one or more grip members 1100B are illustrated with respect to the second cap 110A of FIG. 10 it should be understood that the grip members 1100B may be included on the protrusion 700 of the other caps described herein (e.g. that do not include cavity 400) in combination with the retention features (e.g. such as retention features 700R as shown in FIG. 11) so that the protrusion 700 provides for both transport of the closable tube assembly 100 or second cap 110A and removal of the second cap 110A from the closable tube assembly 100.

In a manner similar to that described respect to grip members 1100A, the grip members 1100B are, in one aspect, configured for a passive engagement with the gripper 1211, 1271. For example, the grip members 1100B are configured to allow passage of the gripper 1211, 1271 around the periphery of the protrusion 700 and rotationally engage the gripper 1211, 1271 substantially without radial or rotational movement of the gripper 1211, 1271 relative to the grip members 1100B that would otherwise cause an active gripping or engagement of the grip members 1100B. In other aspects, the grip members 1100B are configured for an active engagement with the gripper 1211, 1271 such that when the gripper 1211, 1271 substantially surrounds the protrusion 700, the gripper 1211, 1271 moves radially inward to actively engage the grip members 1100B in a manner substantially similar to that described herein with respect to engagement of the retention features 700R. In other aspects the grip members 1100B are configured for active engagement with the gripper 1211, 1271 through at least a partial rotation of the gripper 1211, 1271 relative to the grip members 1100B in any suitable manner.

As may be realized, referring to FIGS. 1A-1D and 13A-13D, the tube vessel 105 of the closable tube assembly 100 may be held rotationally stationary in any suitable manner to effect removal of the second cap 110A from the closable tube assembly 100. For example, a closable tube assembly holding station may include grippers (active or passive) for gripping the tube vessel 105 so that the tube vessel 105 is rotationally fixed relative to the sample holding station. FIGS. 13A-13D illustrate examples of passive grippers for gripping and rotationally fixing the tube vessel 105 of the closable tube assembly 100. FIGS. 13A-13B illustrate an exemplary sample tray 1240 that may have a standard SBS footprint (e.g., length and width), or any other suitable footprint that facilitates manual and/or automated handling of the sample tray 1240. Each of the wells or closable tube assembly holding stations 1240W (e.g., that receive and hold the closable tube assemblies 100) includes at least one respective protrusion that forms a gripper 1240G that engages the closable tube assembly 100 to rotationally fix the tube vessel 105 of the closable tube assembly 100 relative to the sample tray 1240. Here, the gripper 1240G includes a stanchions 1240G1-1240G4 disposed around a perimeter of a respective well 1240W. The stanchions 1240G1, 1240G2 are spaced apart by any suitable distance for receiving the identification plate 130 therebetween. With the closable tube assembly 100 within the well 1240W and with the identification plate 130 disposed between the stanchions 1240G1, 1240G2 engagement of the identification plate 130 with the stanchions 1240G1, 1240G2 (or vice versa) rotationally fixes the tube vessel 105 and the first cap 110M of the closable tube assembly 100 relative to the sample tray 1240 permitting relative rotation between the second cap 110A and the first cap 110M for removal and installation of the second cap 110A from and to the closable tube assembly 100.

In some aspects, the stanchions 1240G3, 1240G4 may also be spaced apart from one another by any suitable distance for receiving the hinge 135 therebetween. With the closable tube assembly 100 within the well 1240W and with the hinge 135 disposed between the stanchions 1240G3, 1240G4 engagement of the hinge 135 with the stanchions 1240G3, 1240G4 (or vice versa) rotationally fixes (alone or in combination with the rotational fixing effected by the identification plate 130 and stanchions 1240G1, 1240G2) the tube vessel 105 and the first cap 110M of the closable tube assembly 100 relative to the sample tray 1240 permitting relative rotation between the second cap 110A and the first cap 110M for removal and installation of the second cap 110A from and to the closable tube assembly 100.

In still other aspects, the stanchions 1240G1-1240G4 may conform to a shape of at least the first cap 110M of the cap assembly 110 for rotationally fixing at least the first cap 110M of the cap assembly 110 relative to the sample tray 1240. For example, the first cap 110M (and/or a collar 105C of the tube vessel 105) may have a non-circular shape (e.g., octagonal, hexagonal, square, rectangular, etc.). The stanchions 1240G1-1240G4 may be arranged relative to each other and the well 1240W so as to engage the sides of the non-circular shape of the first cap 110M (and/or a collar 105C of the tube vessel 105), in a manner similar to that of a wrench gripping a bolt head, so that the stanchions 1240G1-1240G4 rotationally fix the first cap 110M (and/or the collar 105C of the tube vessel 105, and hence the tube vessel 105) relative to the sample tray 1240 independent of or in combination with engagement of the hinge 135 and/or identification plate 130 with the stanchions 1240G1-1240G4.

In other aspects, as illustrated in FIG. 13D, the tube vessel 105 of the closable tube assembly 100 is substantially similar to that illustrated in FIGS. 1A-1D however, in this aspect the closed end of the tube vessel 105 includes orientation or anti-rotational features 1300, 1300′ that engage, for example, corresponding orientation or anti-rotational features 1310 disposed within the holding areas or wells 1240W of the sample trays 1240 or other closable tube assembly holding vessel 1399 (e.g., refrigerated transports, carts of automated conveyors, etc.). The anti-rotational features 1300, 1300′, 1310, 1310′ may have any suitable configuration such as the chamfered/tapered hexagonal shape illustrated in FIG. 13D, a ribbed configuration where the ribs radially extend from the tube vessel 105 (in a manner similar to grip members 1100B), or any other geometrical shape such as, for example, square, triangular, slotted, pentagonal, hexagonal, octagonal, etc. that provides for at least a rotationally coupled engagement between the tube vessel 105 and the sample trays 1240 and/or the other closable tube assembly holding vessel 1399. As noted above, the anti-rotational features 1310, 1310′ of the sample trays 1240 and/or the other closable tube assembly holding vessel 1399 have a shape that corresponds with the shape of the anti-rotational feature 1300 of the tube vessel 105. In one aspect, the shape of orientation or anti-rotational features 1300′, 1310′ is polarized with respect to the sample tray 1240 and/or the other closable tube assembly holding vessel 1399 so that the closable tube assembly 100 is inserted into the sample tray 1240 and/or the other closable tube assembly holding vessel 1399 in a predetermined rotational (about axis CX) orientation relative to the sample tray 1240 and/or the other closable tube assembly holding vessel 1399. In other aspects, the shape of the anti-rotational features 1300, 1310 are not polarized so that the closable tube assembly 100 is inserted in into the sample tray 1240 and/or the other closable tube assembly holding vessel 1399 with any suitable rotational (about axis CX) orientation relative to the sample tray 1240 and/or the other closable tube assembly holding vessel 1399.

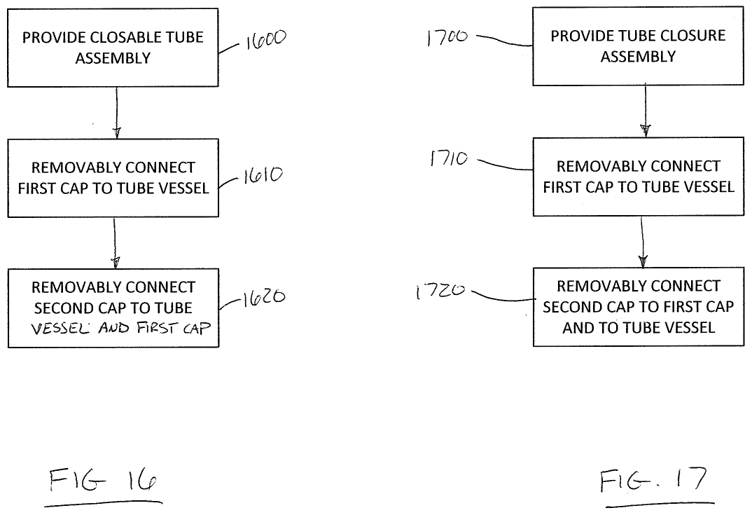

Referring to FIGS. 1-3C and 16 an exemplary method will be described in accordance with the disclosed embodiment. In the method, the closable tube assembly 100 is provided (FIG. 16, Block 1600) and includes the tube vessel 105 with vessel walls 105W defining the opening 105P to an interior 116 of the tube vessel 105, the first cap 110M, and the second cap 110A. The first cap 110M is removably connected to the tube vessel 105 over the opening 105P (FIG. 16, Block 1610), where the first cap engages an edge of the opening 105P and the tube vessel interior 116 so as to close the opening 105P at least in part with the first cap 110M in a closed position on the tube vessel 105. The second cap 110A is removably connected to the tube vessel 105 and the first cap (FIG. 16, Block 1620) so that opening 105P closure is commonly effected by both the first cap 110M and the second cap 110A with the first cap 110M in the closed position. Removal of the second cap 110A opens the opening 105P with the first cap 110M continuously engaged to the edge of the opening 105P substantially maintained in the closed position on the tube vessel 105, where both the first cap 110M and the second cap 110A have an insert closure configuration relative to the opening 105P, and the second cap 110A has an insert configuration relative to the first cap 110M. As described herein the second cap 110A has an interface for automatic repeatable engagement with an automatic machine cap opener AMC (See FIGS. 4-9B). As described herein, the closable tube assembly 100 is provided with more than one tube vessel 105 coupled to each other in a strip of tube vessels 100STR (FIG. 1E), where each tube vessel 105 has a respective first cap 110M and a respective second cap 110A removably coupled thereto. The method further includes automatically decapping the more than one tube vessel 105 in the strip of tube vessels 100STR with the automatic machine cap opener AMC. As also described herein, the closable tube assembly 100 is provided with more than one tube vessel 105 disposed in an array (see, e.g., FIGS. 12 and 13A), where each tube vessel 105 has a respective first cap 110M and a respective second cap 110A removably coupled thereto. The method includes automatically decapping the more than one tube vessel 105 in the array of tube vessels with the automatic machine cap opener AMC.

Referring to FIGS. 1-3C and 17 an exemplary method will be described in accordance with the disclosed embodiment. In the method the tube closure or cap assembly 110 for a tube vessel 105 is provided (FIG. 17, Block 1700), where the tube closure assembly 110 includes a first cap 110M and a second cap 110A. The first cap 110M is removably connected to the tube vessel 105 (FIG. 17, Block 1710) over an opening 105P formed by tube vessel walls 105W, where the first cap 110M engages an edge of the opening 105P and interior 116 of the tube vessel walls 105W, so as to close the opening 105P at least in part with the first cap 110M in a closed position on the tube vessel 105. The second cap 110A is removably coupled to the first cap 110M, and to the tube vessel 105 via the first cap 110M, (FIG. 17, Block 1720) so that closure of the opening 105P is commonly effected by both the first cap 110M and the second cap 110A with the first cap 110M in the closed position. Removal of the second cap 110A opens the opening 105P with the first cap 110M continuously engaged to the edge of the opening 105P substantially maintained in the closed position on the tube vessel 105, where both the first cap 110M and the second cap 110A have an insert closure configuration relative to the opening 105P, and the second cap 110A has an insert configuration relative to the first cap 110M. The second cap 110A has an interface 120 for automatic repeatable engagement with an automatic machine cap opener AMC.

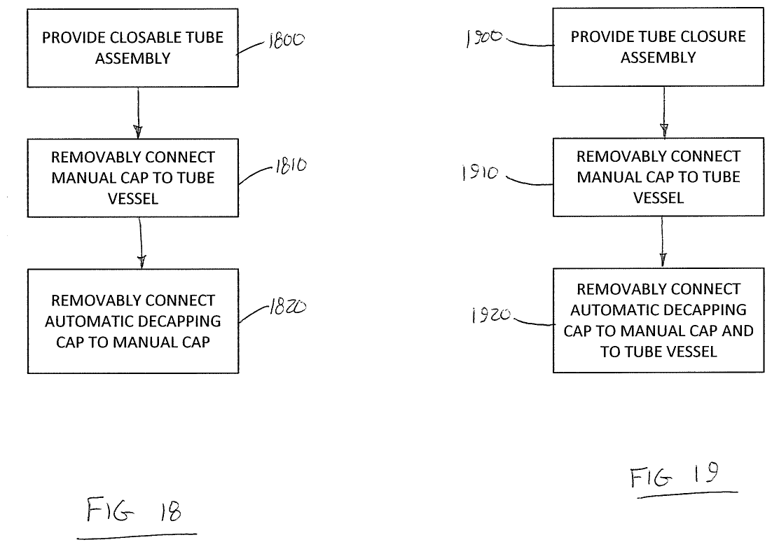

Referring to FIGS. 1-3C and 18 an exemplary method will be described in accordance with the disclosed embodiment. In the method a closable tube assembly 100 is provided (FIG. 18, Block 1800). The closable tube assembly 100 includes a tube vessel 105 with vessel walls 105W defining an opening 105P to an interior 116 of the tube vessel 105, a manual or first cap 110M, and an automatic decapping or second cap 110A. The manual cap 110M is removably connected to the tube vessel 105 over the opening 105P (FIG. 18, Block 1810), where the manual cap 110M engages an edge of the opening 105P and the tube vessel interior 116 so as to close the opening 105P at least in part with the manual cap 110M in a closed position on the tube vessel 105. The automatic decapping cap 110A is removably coupled to the manual cap 110M (FIG. 18, Block 1820) so as to close the opening 105P and that opening 105P closure is commonly effected by both the manual cap 110M and the automatic decapping cap 110A with the manual cap 110M in the closed position. The automation decapping cap 110A is sized and shaped for automatic repeatable engagement with the automatic decapping machine AMC that automatically decaps the automatic decapping cap 110A and opens the opening 105P with the manual cap 110M staying engaged to the edge of the opening 105P substantially maintained (unmoved) in the closed position on the tube vessel 105. Each interface between the automatic decapping cap 110A and the automatic decapping machine AMC effecting decapping automatically is disposed within an outermost perimeter of the manual cap 110M, as described herein. As described herein, in some aspects, the closable tube assembly 100 is provided with more than one tube vessel 105 coupled to each other in a strip of tube vessels 100STR, where each tube vessel 105 has a respective manual cap 110M and a respective automatic decapping cap 110A removably coupled thereto. The method further includes automatically decapping the more than one tube vessel 105 in the strip of tube vessels 100STR with the automatic machine cap opener AMC. As described herein, in some aspects, the closable tube assembly 100 is provided with more than one tube vessel 105 disposed in an array (see FIGS. 12 and 13A), where each tube vessel 105 has a respective manual cap 110M and a respective automatic decapping cap 110A removably coupled thereto. The method further includes automatically decapping the more than one tube vessel 105 in the array of tube vessels with the automatic machine cap opener AMC.

Referring to FIGS. 1-3C and 19 an exemplary method will be described in accordance with the disclosed embodiment. In the method a tube closure or cap assembly 110 for a tube vessel 105 is provided (FIG. 19, Block 1900). The tube closure assembly 110 includes a manual cap 110M and an automatic decapping cap 110A. The manual cap 110M is removably coupled to the tube vessel 105 over an opening 105P formed by tube vessel walls 105W (FIG. 19, Block 1910), where the manual cap 110M engages an edge of the opening 105P and interior 116 of the tube vessel walls 105W, so as to close the opening 105P at least in part with the manual cap 110M in a closed position on the tube vessel 105. The automatic decapping cap 110A is removably coupled to the manual cap 110M, and to the tube vessel 105 via the manual cap 110M, (FIG. 19, Block 1920) so that closure of the opening 105P is commonly effected by both the manual cap 110M and the automatic decapping cap 110A with the manual cap 110M in the closed position. The automation decapping cap 110A is sized and shaped for automatic repeatable engagement with the automatic decapping machine AMC that automatically decaps the automatic decapping cap 110A and opens the opening 105P with the manual cap 110M staying engaged to the edge of the opening 105P substantially maintained in the closed position on the tube vessel 105. As described herein, each interface between the automatic decapping cap 110A and the automatic decapping machine AMC effecting decapping automatically is disposed within an outermost perimeter of the manual cap 110M. As described herein, in some aspects, the tube closure assembly 110 is provided with more than one tube vessel 105 coupled to each other in a strip of tube vessels 100STR, each tube vessel 105 having a respective manual cap 110M and a respective automatic decapping cap 110A removably coupled thereto. The method further includes automatically decapping the more than one tube vessel 105 in the strip of tube vessels 100STR with the automatic machine cap opener AMC. As described herein, the tube closure assembly 110 is provided with more than one tube vessel 105 disposed in an array (See FIGS. 12 and 13A), where each tube vessel 105 has a respective manual cap 110M and a respective automatic decapping cap 110A removably coupled thereto. The method further includes automatically decapping the more than one tube vessel 105 in the array of tube vessels with the automatic machine cap opener AMC.

In accordance with one or more aspects of the disclosed embodiment a closable tube assembly includes: a tube vessel with vessel walls defining an opening to an interior of the tube vessel; a first cap removably connected to the tube vessel over the opening, the first cap being configured to engage an edge of the opening and the tube vessel interior so as to close the opening at least in part with the first cap in a closed position on the tube vessel; and a second cap removably connected to the tube vessel and the first cap so that opening closure is commonly effected by both the first cap and the second cap with the first cap in the closed position, wherein removal of the second cap opens the opening with the first cap continuously engaged to the edge of the opening substantially maintained in the closed position on the tube vessel, wherein both the first cap and the second cap have an insert closure configuration relative to the opening, and the second cap has an insert configuration relative to the first cap; and the second cap has an interface for automatic repeatable engagement with an automatic machine cap opener.

In accordance with one or more aspects of the disclosed embodiment the first cap has a threaded plug closure configuration with respect to the opening, with interior threads disposed so as to engage the second cap inserted into the first cap in a closed position on the first cap.

In accordance with one or more aspects of the disclosed embodiment the interface for automatic repeatable engagement with the automatic machine cap opener has a configuration wherein fit up and engagement between the second cap and the automatic machine cap opener is effected via the interface and exclusive of the first cap.

In accordance with one or more aspects of the disclosed embodiment the second cap is received within the first cap with the second cap in the closed position.

In accordance with one or more aspects of the disclosed embodiment the closable tube assembly is a PCR tube assembly with at least a 0.2 mL tube vessel.

In accordance with one or more aspects of the disclosed embodiment the first cap is hinged to the tube vessel with a hinge member joining the first tube cap to the tube vessel.

In accordance with one or more aspects of the disclosed embodiment the hinge member hinges both the first cap and the second cap, assembled with each other so as to form a cap in cap assembly, to the tube vessel.

In accordance with one or more aspects of the disclosed embodiment the closable tube assembly includes more than one tube vessel coupled to each other in a strip of tube vessels, each tube vessel having a respective first cap and a respective second cap removably coupled thereto.

In accordance with one or more aspects of the disclosed embodiment the closable tube assembly of includes more than one tube vessel disposed in an array, each tube vessel having a respective first cap and a respective second cap removably coupled thereto.

In accordance with one or more aspects of the disclosed embodiment the more than one tube vessel are disposed in the array within in a tube vessel tray or tube vessel storage.

In accordance with one or more aspects of the disclosed embodiment a tube closure assembly for a tube vessel, the closure assembly includes: a first cap configured so as to be removably connected to the tube vessel over an opening formed by tube vessel walls, the first cap being configured to engage an edge of the opening and interior of the tube vessel walls, so as to close the opening at least in part with the first cap in a closed position on the tube vessel; and a second cap removably connected to the first cap, and to the tube vessel via the first cap, so that closure of the opening is commonly effected by both the first cap and the second cap with the first cap in the closed position, wherein removal of the second cap opens the opening with the first cap continuously engaged to the edge of the opening substantially maintained in the closed position on the tube vessel, wherein both the first cap and the second cap have an insert closure configuration relative to the opening, and the second cap has an insert configuration relative to the first cap; and the second cap has an interface for automatic repeatable engagement with an automatic machine cap opener.

In accordance with one or more aspects of the disclosed embodiment the first cap has a threaded plug closure configuration with respect to the opening, with interior threads disposed so as to engage the second cap inserted into the first cap in a closed position on the first cap.

In accordance with one or more aspects of the disclosed embodiment the interface for automatic repeatable engagement with the automatic machine cap opener has a configuration wherein fit up and engagement between the second cap and the automatic machine cap opener is effected via the interface and exclusive of the first cap.

In accordance with one or more aspects of the disclosed embodiment the second cap is received within the first cap with the second cap in a closed position.

In accordance with one or more aspects of the disclosed embodiment the first cap is configured to removably connect to the tube vessel having a PCR tube vessel configuration with at least a 0.2 mL tube vessel volume.

In accordance with one or more aspects of the disclosed embodiment the first cap is hinged to the tube vessel with a hinge member joining the first tube cap to the tube vessel.

In accordance with one or more aspects of the disclosed embodiment the hinge member hinges both the first cap and the second cap, assembled with each other so as to form a cap in cap assembly, to the tube vessel.

In accordance with one or more aspects of the disclosed embodiment a closable tube assembly includes: a tube vessel with vessel walls defining an opening to an interior of the tube vessel; a manual cap removably connected to the tube vessel over the opening, the manual cap being configured to engage an edge of the opening and the tube vessel interior so as to close the opening at least in part with the manual cap in a closed position on the tube vessel; and an automatic decapping cap removably connected to the manual cap so as to close the opening and that opening closure is commonly effected by both the manual cap and the automatic decapping cap with the manual cap in the closed position, wherein the automation decapping cap is sized and shaped for automatic repeatable engagement with an automatic decapping machine that automatically decaps the automatic decapping cap and opens the opening with the manual cap staying engaged to the edge of the opening substantially maintained (unmoved) in the closed position on the tube vessel; wherein each interface between the automatic decapping cap and the automatic decapping machine effecting decapping automatically is disposed within an outermost perimeter of the manual cap.

In accordance with one or more aspects of the disclosed embodiment the manual cap has a recess that receives therein the automatic decapping cap so that each interface between the automatic decapping cap and automatic decapping machine is recessed within the manual cap substantially in entirety.

In accordance with one or more aspects of the disclosed embodiment both the manual cap and the automatic decapping cap have an insert closure configuration relative to the opening, and the automatic decapping cap has an insert configuration relative to the manual cap.

In accordance with one or more aspects of the disclosed embodiment automatic decapping of the automatic decapping cap decaps the tube vessel and opens the opening.

In accordance with one or more aspects of the disclosed embodiment the manual cap has a threaded plug closure configuration with respect to the opening, with interior threads disposed so as to engage the automatic decapping cap inserted into the manual cap in a closed position on the manual cap.

In accordance with one or more aspects of the disclosed embodiment the interface effects automatic repeatable engagement with the automatic decapping machine and has a configuration wherein fit up and engagement between the automatic decapping cap and the automatic decapping machine is effected via the interface and exclusive of the manual cap.

In accordance with one or more aspects of the disclosed embodiment the automatic decapping cap is received within the manual cap with the automatic decapping cap in the closed position.

In accordance with one or more aspects of the disclosed embodiment the closable tube assembly is a PCR tube assembly with at least a 0.2 mL tube vessel.

In accordance with one or more aspects of the disclosed embodiment the manual cap is hinged to the tube vessel with a hinge member joining the manual tube cap to the tube vessel.

In accordance with one or more aspects of the disclosed embodiment the hinge member hinges both the manual cap and the automatic decapping cap, assembled with each other so as to form a cap in cap assembly, to the tube vessel.

In accordance with one or more aspects of the disclosed embodiment the closable tube assembly includes more than one tube vessel coupled to each other in a strip of tube vessels, each tube vessel having a respective manual cap and a respective automatic decapping cap removably coupled thereto.

In accordance with one or more aspects of the disclosed embodiment the closable tube assembly includes more than one tube vessel disposed in an array, each tube vessel having a respective manual cap and a respective automatic decapping cap removably coupled thereto.

In accordance with one or more aspects of the disclosed embodiment tube closure assembly for a tube vessel, the tube closure assembly includes: a manual cap configured so as to be removably connected to the tube vessel over an opening formed by tube vessel walls, the manual cap being configured to engage an edge of the opening and interior of the tube vessel walls, so as to close the opening at least in part with the manual cap in a closed position on the tube vessel; and an automatic decapping cap removably connected to the manual cap, and to the tube vessel via the manual cap, so that closure of the opening is commonly effected by both the manual cap and the automatic decapping cap with the manual cap in the closed position, wherein the automation decapping cap is sized and shaped for automatic repeatable engagement with an automatic decapping machine that automatically decaps the automatic decapping cap and opens the opening with the manual cap staying engaged to the edge of the opening substantially maintained in the closed position on the tube vessel; wherein each interface between the automatic decapping cap and the automatic decapping machine effecting decapping automatically is disposed within an outermost perimeter of the manual cap.

In accordance with one or more aspects of the disclosed embodiment the manual cap has a recess that receives therein the automatic decapping cap so that each interface between the automatic decapping cap and automatic decapping machine is recessed within the manual cap substantially in entirety.

In accordance with one or more aspects of the disclosed embodiment both the manual cap and the automatic decapping cap have an insert closure configuration relative to the opening, and the automatic decapping cap has an insert configuration relative to the manual cap.

In accordance with one or more aspects of the disclosed embodiment automatic decapping of the automatic decapping cap decaps the tube vessel and opens the opening.

In accordance with one or more aspects of the disclosed embodiment the manual cap has a threaded plug closure configuration with respect to the opening, with interior threads disposed so as to engage the automatic decapping cap inserted into the manual cap in a closed position on the manual cap.

In accordance with one or more aspects of the disclosed embodiment the interface effects automatic repeatable engagement with the automatic decapping machine and has a configuration wherein fit up and engagement between the automatic decapping cap and the automatic decapping machine is effected via the interface and exclusive of the manual cap.

In accordance with one or more aspects of the disclosed embodiment the automatic decapping cap is received within the manual cap with the automatic decapping cap in the closed position.

In accordance with one or more aspects of the disclosed embodiment the closable tube assembly is a PCR tube assembly with at least a 0.2 mL tube vessel.

In accordance with one or more aspects of the disclosed embodiment the manual cap is hinged to the tube vessel with a hinge member joining the manual tube cap to the tube vessel.

In accordance with one or more aspects of the disclosed embodiment the hinge member hinges both the manual cap and the automatic decapping cap, assembled with each other so as to form a cap in cap assembly, to the tube vessel.

In accordance with one or more aspects of the disclosed embodiment the tube closure assembly includes more than one tube vessel coupled to each other in a strip of tube vessels, each tube vessel having a respective manual cap and a respective automatic decapping cap removably coupled thereto.

In accordance with one or more aspects of the disclosed embodiment the tube closure assembly includes more than one tube vessel disposed in an array, each tube vessel having a respective manual cap and a respective automatic decapping cap removably coupled thereto.

In accordance with one or more aspects of the disclosed embodiment method includes: providing a closable tube assembly, the closable tube assembly includes: a tube vessel with vessel walls defining an opening to an interior of the tube vessel, a first cap, and a second cap; removably connecting the first cap to the tube vessel over the opening, the first cap engaging an edge of the opening and the tube vessel interior so as to close the opening at least in part with the first cap in a closed position on the tube vessel; and removably connecting the second cap to the tube vessel and the first cap so that opening closure is commonly effected by both the first cap and the second cap with the first cap in the closed position, wherein removal of the second cap opens the opening with the first cap continuously engaged to the edge of the opening substantially maintained in the closed position on the tube vessel, wherein both the first cap and the second cap have an insert closure configuration relative to the opening, and the second cap has an insert configuration relative to the first cap; and wherein the second cap has an interface for automatic repeatable engagement with an automatic machine cap opener.

In accordance with one or more aspects of the disclosed embodiment the first cap has a threaded plug closure configuration with respect to the opening, with interior threads disposed so as to engage the second cap inserted into the first cap in a closed position on the first cap.

In accordance with one or more aspects of the disclosed embodiment the interface for automatic repeatable engagement with the automatic machine cap opener has a configuration wherein fit up and engagement between the second cap and the automatic machine cap opener is effected via the interface and exclusive of the first cap.

In accordance with one or more aspects of the disclosed embodiment the second cap is received within the first cap with the second cap in the closed position.

In accordance with one or more aspects of the disclosed embodiment the closable tube assembly is a PCR tube assembly with at least a 0.2 mL tube vessel.

In accordance with one or more aspects of the disclosed embodiment the first cap is hinged to the tube vessel with a hinge member joining the first tube cap to the tube vessel.

In accordance with one or more aspects of the disclosed embodiment the hinge member hinges both the first cap and the second cap, assembled with each other so as to form a cap in cap assembly, to the tube vessel.

In accordance with one or more aspects of the disclosed embodiment the closable tube assembly is provided with more than one tube vessel coupled to each other in a strip of tube vessels, each tube vessel having a respective first cap and a respective second cap removably coupled thereto.

In accordance with one or more aspects of the disclosed embodiment the method further includes automatically decapping the more than one tube vessel in the strip of tube vessels with the automatic machine cap opener.

In accordance with one or more aspects of the disclosed embodiment the closable tube assembly is provided with more than one tube vessel disposed in an array, each tube vessel having a respective first cap and a respective second cap removably coupled thereto.

In accordance with one or more aspects of the disclosed embodiment the more than one tube vessel are disposed in the array within in a tube vessel tray or tube vessel storage.

In accordance with one or more aspects of the disclosed embodiment the method further includes automatically decapping the more than one tube vessel in the array of tube vessels with the automatic machine cap opener.

In accordance with one or more aspects of the disclosed embodiment method includes: providing a tube closure assembly for a tube vessel, the tube closure assembly comprising a first cap and a second cap; removably connecting the first cap to the tube vessel over an opening formed by tube vessel walls, the first cap engaging an edge of the opening and interior of the tube vessel walls, so as to close the opening at least in part with the first cap in a closed position on the tube vessel; and removably connecting the second cap to the first cap, and to the tube vessel via the first cap, so that closure of the opening is commonly effected by both the first cap and the second cap with the first cap in the closed position, wherein removal of the second cap opens the opening with the first cap continuously engaged to the edge of the opening substantially maintained in the closed position on the tube vessel, wherein both the first cap and the second cap have an insert closure configuration relative to the opening, and the second cap has an insert configuration relative to the first cap; and wherein the second cap has an interface for automatic repeatable engagement with an automatic machine cap opener.

In accordance with one or more aspects of the disclosed embodiment the first cap has a threaded plug closure configuration with respect to the opening, with interior threads disposed so as to engage the second cap inserted into the first cap in a closed position on the first cap.

In accordance with one or more aspects of the disclosed embodiment the interface for automatic repeatable engagement with the automatic machine cap opener has a configuration wherein fit up and engagement between the second cap and the automatic machine cap opener is effected via the interface and exclusive of the first cap.

In accordance with one or more aspects of the disclosed embodiment the second cap is received within the first cap with the second cap in a closed position.

In accordance with one or more aspects of the disclosed embodiment the first cap is configured to removably connect to the tube vessel having a PCR tube vessel configuration with at least a 0.2 mL tube vessel volume.

In accordance with one or more aspects of the disclosed embodiment the first cap is hinged to the tube vessel with a hinge member joining the first tube cap to the tube vessel.

In accordance with one or more aspects of the disclosed embodiment the hinge member hinges both the first cap and the second cap, assembled with each other so as to form a cap in cap assembly, to the tube vessel.

In accordance with one or more aspects of the disclosed embodiment method includes: providing a closable tube assembly, the closable tube assembly includes: a tube vessel with vessel walls defining an opening to an interior of the tube vessel, a manual cap, and an automatic decapping cap; removably connecting the manual cap to the tube vessel over the opening, the manual cap engaging an edge of the opening and the tube vessel interior so as to close the opening at least in part with the manual cap in a closed position on the tube vessel; and removably connecting the automatic decapping cap to the manual cap so as to close the opening and that opening closure is commonly effected by both the manual cap and the automatic decapping cap with the manual cap in the closed position, wherein the automation decapping cap is sized and shaped for automatic repeatable engagement with an automatic decapping machine that automatically decaps the automatic decapping cap and opens the opening with the manual cap staying engaged to the edge of the opening substantially maintained (unmoved) in the closed position on the tube vessel; wherein each interface between the automatic decapping cap and the automatic decapping machine effecting decapping automatically is disposed within an outermost perimeter of the manual cap.

In accordance with one or more aspects of the disclosed embodiment the manual cap has a recess that receives therein the automatic decapping cap so that each interface between the is automatic decapping cap and automatic decapping machine: recessed within the manual cap substantially in entirety.

In accordance with one or more aspects of the disclosed embodiment both the manual cap and the automatic decapping cap have an insert closure configuration relative to the opening, and the automatic decapping cap has an insert configuration relative to the manual cap.

In accordance with one or more aspects of the disclosed embodiment automatic decapping of the automatic decapping cap decaps the tube vessel and opens the opening.

In accordance with one or more aspects of the disclosed embodiment the manual cap has a threaded plug closure configuration with respect to the opening, with interior threads disposed so as to engage the automatic decapping cap inserted into the manual cap in a closed position on the manual cap.

In accordance with one or more aspects of the disclosed embodiment the interface effects automatic repeatable engagement with the automatic decapping machine and has a configuration wherein fit up and engagement between the automatic decapping cap and the automatic decapping machine is effected via the interface and exclusive of the manual cap.

In accordance with one or more aspects of the disclosed embodiment the automatic decapping cap is received within the manual cap with the automatic decapping cap in the closed position.

In accordance with one or more aspects of the disclosed embodiment the closable tube assembly is a PCR tube assembly with at least a 0.2 mL tube vessel.

In accordance with one or more aspects of the disclosed embodiment the manual cap is hinged to the tube vessel with a hinge member joining the manual tube cap to the tube vessel.

In accordance with one or more aspects of the disclosed embodiment the hinge member hinges both the manual cap and the automatic decapping cap, assembled with each other so as to form a cap in cap assembly, to the tube vessel.

In accordance with one or more aspects of the disclosed embodiment the closable tube assembly is provided with more than one tube vessel coupled to each other in a strip of tube vessels, each tube vessel having a respective manual cap and a respective automatic decapping cap removably coupled thereto.

In accordance with one or more aspects of the disclosed embodiment the method further includes automatically decapping the more than one tube vessel in the strip of tube vessels with the automatic machine cap opener.

In accordance with one or more aspects of the disclosed embodiment the closable tube assembly is provided with more than one tube vessel disposed in an array, each tube vessel having a respective manual cap and a respective automatic decapping cap removably coupled thereto.

In accordance with one or more aspects of the disclosed embodiment the more than one tube vessel are disposed in the array within in a tube vessel tray or tube vessel storage.

In accordance with one or more aspects of the disclosed embodiment method further includes automatically decapping the more than one tube vessel in the array of tube vessels with the automatic machine cap opener.

In accordance with one or more aspects of the disclosed embodiment method includes: providing a tube closure assembly for a tube vessel, the tube closure assembly comprising a manual cap and an automatic decapping cap; removably connecting the manual cap to the tube vessel over an opening formed by tube vessel walls, the manual cap engaging an edge of the opening and interior of the tube vessel walls, so as to close the opening at least in part with the manual cap in a closed position on the tube vessel; and removably connecting the automatic decapping cap to the manual cap, and to the tube vessel via the manual cap, so that closure of the opening is commonly effected by both the manual cap and the automatic decapping cap with the manual cap in the closed position, wherein the automation decapping cap is sized and shaped for automatic repeatable engagement with an automatic decapping machine that automatically decaps the automatic decapping cap and opens the opening with the manual cap staying engaged to the edge of the opening substantially maintained in the closed position on the tube vessel; wherein each interface between the automatic decapping cap and the automatic decapping machine effecting decapping automatically is disposed within an outermost perimeter of the manual cap.

In accordance with one or more aspects of the disclosed embodiment the manual cap has a recess that receives therein the automatic decapping cap so that each interface between the automatic decapping cap and automatic decapping machine is recessed within the manual cap substantially in entirety.

In accordance with one or more aspects of the disclosed embodiment both the manual cap and the automatic decapping cap have an insert closure configuration relative to the opening, and the automatic decapping cap has an insert configuration relative to the manual cap.

In accordance with one or more aspects of the disclosed embodiment automatic decapping of the automatic decapping cap decaps the tube vessel and opens the opening.

In accordance with one or more aspects of the disclosed embodiment the manual cap has a threaded plug closure configuration with respect to the opening, with interior threads disposed so as to engage the automatic decapping cap inserted into the manual cap in a closed position on the manual cap.

In accordance with one or more aspects of the disclosed embodiment the interface effects automatic repeatable engagement with the automatic decapping machine and has a configuration wherein fit up and engagement between the automatic decapping cap and the automatic decapping machine is effected via the interface and exclusive of the manual cap.

In accordance with one or more aspects of the disclosed embodiment the automatic decapping cap is received within the manual cap with the automatic decapping cap in the closed position.

In accordance with one or more aspects of the disclosed embodiment the closable tube assembly is a PCR tube assembly with at least a 0.2 mL tube vessel.

In accordance with one or more aspects of the disclosed embodiment the manual cap is hinged to the tube vessel with a hinge member joining the manual tube cap to the tube vessel.

In accordance with one or more aspects of the disclosed embodiment the hinge member hinges both the manual cap and the automatic decapping cap, assembled with each other so as to form a cap in cap assembly, to the tube vessel.

In accordance with one or more aspects of the disclosed embodiment the tube closure assembly is provided with more than one tube vessel coupled to each other in a strip of tube vessels, each tube vessel having a respective manual cap and a respective automatic decapping cap removably coupled thereto.

In accordance with one or more aspects of the disclosed embodiment the method further includes automatically decapping the more than one tube vessel in the strip of tube vessels with the automatic machine cap opener.

In accordance with one or more aspects of the disclosed embodiment the tube closure assembly is provided with more than one tube vessel disposed in an array, each tube vessel having a respective manual cap and a respective automatic decapping cap removably coupled thereto.

In accordance with one or more aspects of the disclosed embodiment the more than one tube vessel are disposed in the array within in a tube vessel tray or tube vessel storage.

In accordance with one or more aspects of the disclosed embodiment the method further includes automatically decapping the more than one tube vessel in the array of tube vessels with the automatic machine cap opener.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the disclosed embodiment.

What is claimed is:

1. A closable tube assembly comprising:
a tube vessel with vessel walls defining an opening to an interior of the tube vessel;
a first cap removably connected to the tube vessel over the opening, the first cap being configured to engage an edge of the opening and the tube vessel interior so as to close the opening at least in part with the first cap in a closed position on the tube vessel; and
a second cap removably connected to the tube vessel and the first cap so that opening closure is commonly effected by both the first cap and the second cap with the first cap in the closed position, wherein removal of the second cap opens the opening with the first cap continuously engaged to the edge of the opening substantially maintained in the closed position on the tube vessel, wherein both the first cap and the second cap have an insert closure configuration relative to the opening, and the second cap has an insert configuration relative to the first cap; and
the second cap has an interface for automatic repeatable engagement with an automatic machine cap opener.

2. The closable tube assembly of claim 1, wherein the first cap has a threaded plug closure configuration with respect to the opening, with interior threads disposed so as to engage the second cap inserted into the first cap in a closed position on the first cap.

3. The closable tube assembly of claim 1, wherein the interface for automatic repeatable engagement with the automatic machine cap opener has a configuration wherein fit up and engagement between the second cap and the automatic machine cap opener is effected via the interface and exclusive of the first cap.

4. The closable tube assembly of claim 1, wherein the second cap is received within the first cap with the second cap in the closed position.

5. The closable tube assembly of claim 1, wherein the closable tube assembly is a PCR tube assembly with at least a 0.2 mL tube vessel.

6. The closable tube assembly of claim 1, wherein the first cap is hinged to the tube vessel with a hinge member joining the first tube cap to the tube vessel.

7. The closable tube assembly of claim 6, wherein the hinge member hinges both the first cap and the second cap, assembled with each other so as to form a cap in cap assembly, to the tube vessel.

8. The closable tube assembly of claim 1, comprising more than one tube vessel coupled to each other in a strip of tube vessels, each tube vessel having a respective first cap and a respective second cap removably coupled thereto.

9. The closable tube assembly of claim 1, comprising more than one tube vessel disposed in an array, each tube vessel having a respective first cap and a respective second cap removably coupled thereto.

10. The closable tube assembly of claim 9, wherein the more than one tube vessel are disposed in the array within in a tube vessel tray or tube vessel storage.

11. A tube closure assembly for a tube vessel, the tube closure assembly comprising:
a first cap configured so as to be removably connected to the tube vessel over an opening formed by tube vessel walls, the first cap being configured to engage an edge of the opening and interior of the tube vessel walls, so as to close the opening at least in part with the first cap in a closed position on the tube vessel; and
a second cap removably connected to the first cap, and to the tube vessel via the first cap, so that closure of the opening is commonly effected by both the first cap and the second cap with the first cap in the closed position, wherein removal of the second cap opens the opening with the first cap continuously engaged to the edge of the opening substantially maintained in the closed position on the tube vessel, wherein both the first cap and the second cap have an insert closure configuration relative to the opening, and the second cap has an insert configuration relative to the first cap; and
the second cap has an interface for automatic repeatable engagement with an automatic machine cap opener.

12. The tube closure assembly of claim 11, wherein the first cap has a threaded plug closure configuration with respect to the opening, with interior threads disposed so as to engage the second cap inserted into the first cap in a closed position on the first cap.

13. The tube closure assembly of claim 11, wherein the interface for automatic repeatable engagement with the automatic machine cap opener has a configuration wherein fit up and engagement between the second cap and the automatic machine cap opener is effected via the interface and exclusive of the first cap.

14. The tube closure assembly of claim 11, wherein the second cap is received within the first cap with the second cap in a closed position.

15. The tube closure assembly of claim 11, wherein the first cap is configured to removably connect to the tube vessel having a PCR tube vessel configuration with at least a 0.2 mL tube vessel volume.

16. The tube closure assembly of claim 11, wherein the first cap is hinged to the tube vessel with a hinge member joining the first tube cap to the tube vessel.

17. The tube closure assembly of claim 16, wherein the hinge member hinges both the first cap and the second cap, assembled with each other so as to form a cap in cap assembly, to the tube

18. A closable tube assembly comprising:
a tube vessel with vessel walls defining an opening to an interior of the tube vessel;
a manual cap removably connected to the tube vessel over the opening, the manual cap being configured to engage an edge of the opening and the tube vessel interior so as to close the opening at least in part with the manual cap in a closed position on the tube vessel; and
an automatic decapping cap removably connected to the manual cap so as to close the opening and that opening closure is commonly effected by both the manual cap and the automatic decapping cap with the manual cap in the closed position, wherein the automation decapping cap is sized and shaped for automatic repeatable engagement with an automatic decapping machine that automatically decaps the automatic decapping cap and opens the opening with the manual cap staying engaged to the edge of the opening substantially maintained in the closed position on the tube vessel;
wherein each interface between the automatic decapping cap and the automatic decapping machine effecting decapping automatically is disposed within an outermost perimeter of the manual cap.

19. The closable tube assembly of claim 18, wherein the manual cap has a recess that receives therein the automatic decapping cap so that each interface between the automatic decapping cap and automatic decapping machine is recessed within the manual cap substantially in entirety.

20. The closable tube assembly of claim 18, wherein both the manual cap and the automatic decapping cap have an insert closure configuration relative to the opening, and the automatic decapping cap has an insert configuration relative to the manual cap.

21. The closable tube assembly of claim 18, wherein automatic decapping of the automatic decapping cap decaps the tube vessel and opens the opening.

22. The closable tube assembly of claim 18, wherein the manual cap has a threaded plug closure configuration with respect to the opening, with interior threads disposed so as to engage the automatic decapping cap inserted into the manual cap in a closed position on the manual cap.

23. The closable tube assembly of claim 18, wherein the interface effects automatic repeatable engagement with the automatic decapping machine and has a configuration wherein fit up and engagement between the automatic decapping cap and the automatic decapping machine is effected via the interface and exclusive of the manual cap.

24. The closable tube assembly of claim 18, wherein the automatic decapping cap is received within the manual cap with the automatic decapping cap in the closed position.

25. The closable tube assembly of claim 18, wherein the closable tube assembly is a PCR tube assembly with at least a 0.2 mL tube vessel.

26. The closable tube assembly of claim 18, wherein the manual cap is hinged to the tube vessel with a hinge member joining the manual tube cap to the tube vessel.

27. The closable tube assembly of claim 26, wherein the hinge member hinges both the manual cap and the automatic decapping cap, assembled with each other so as to form a cap in cap assembly, to the tube vessel.

28. The closable tube assembly of claim 18, comprising more than one tube vessel coupled to each other in a strip of tube vessels, each tube vessel having a respective manual cap and a respective automatic decapping cap removably coupled thereto.

29. The closable tube assembly of claim 18, comprising more than one tube vessel disposed in an array, each tube vessel having a respective manual cap and a respective automatic decapping cap removably coupled thereto.
